(19) United States
(12) Patent Application Publication
(10) Pub. No.: US 2024/0348377 A1
(43) Pub. Date: Oct. 17, 2024

(54) USER EQUIPMENT AND METHOD FOR HANDLING HYBRID AUTOMATIC REPEAT REQUEST-ACKNOWLEDGMENT CODEBOOK TRANSMISSION

(71) Applicant: FG Innovation Company Limited, Tuen Mun (HK)

(72) Inventors: HAI-HAN WANG, Taipei (TW); CHIA-HUNG WEI, Taipei (TW)

(21) Appl. No.: 18/294,430

(22) PCT Filed: Aug. 11, 2022
(86) PCT No.: PCT/CN2022/111817

§ 371 Date: Feb. 1, 2024

Related U.S. Application Data
(60) Provisional application No. 63/233,246, filed on Aug. 14, 2021.

(51) Int. Cl. H04L 1/1829; H04L 1/1867; H04W 72/11

(52) U.S. Cl. CPC H04L 1/1861; H04L 1/1896; H04W 72/11

(57) ABSTRACT

A UE and a method for handling HARQ-ACK codebook transmission are provided. The method includes receiving, from a BS, a first configuration for unicast configuration for unicast SPS PDSCH, a second configuration for multicast SPS PDSCH, and a third configuration for unicast PDSCH; receiving, from the BS, a PUCCH configuration for unicast; receiving DCI scheduling a unicast PDSCH; determining a Type-1 HARQ-ACK codebook corresponding to the unicast PDSCH based on the first configuration for unicast SPS PDSCH, the second configuration for multicast SPS PDSCH, and the third configuration for unicast PDSCH; and transmitting, to the BS, the Type-1 HARQ-ACK codebook corresponding to the unicast PDSCH in a first slot.

### FIELD

The present disclosure is related to wireless communication, and more specifically, to a user equipment (UE) and a method for handling hybrid automatic repeat request (HARQ)-acknowledgment (ACK) codebook transmission in the next-generation wireless communication network.

### BACKGROUND

With the tremendous growth in the number of connected devices and the rapid increase in user/network traffic volume, various efforts have been made to improve different aspects of wireless communication for the next-generation wireless communication system, such as 5G NR, by improving data rate, latency, reliability, and mobility.

The 5G NR system is designed to provide flexibility and configurability for optimizing the network services and types and accommodating various use cases such as eMBB, mMTC, and URLLC.

However, as the demand for radio access continues to increase, there is a need for further improvements in wireless communication for the next-generation wireless communication system.

### SUMMARY

The present disclosure is related to a method for handling HARQ-ACK transmission performed by a UE.

According to a first aspect of the present disclosure, a method for handling HARQ-ACK transmission performed by a UE is provided. The method includes receiving, from a base station (BS), a first configuration for unicast semi-persistent scheduling (SPS) physical downlink shared channel (PDSCH), a second configuration for multicast SPS PDSCH, and a third configuration for unicast PDSCH; receiving, from the BS, a physical uplink control channel (PUCCH) configuration for unicast; receiving, from the BS, downlink control information (DCI) scheduling a unicast PDSCH; determining a Type-1 HARQ-ACK codebook corresponding to the unicast PDSCH based on the first configuration for unicast SPS PDSCH, the second configuration for multicast SPS PDSCH, and the third configuration for unicast PDSCH; and transmitting, to the BS, the Type-1 HARQ-ACK codebook corresponding to the unicast PDSCH in a first slot.

According to an implementation of the first aspect, the first configuration for unicast SPS PDSCH configures a first number of PDSCH repetitions; the second configuration for multicast SPS PDSCH configures a second number of PDSCH repetitions; and the third configuration for unicast PDSCH configures a third number of PDSCH repetitions.

According to a second aspect of the present disclosure, a UE for handling HARQ-ACK transmission is provided. The UE includes one or more non-transitory computer-readable media having computer-executable instructions embodied therein; and at least one processor coupled to the one or more non-transitory computer-readable media, the at least one processor configured to execute the computer-executable instructions to cause the UE to receive, from a BS, a first configuration for unicast SPS PDSCH, a second configuration for multicast SPS PDSCH, and a third configuration for unicast PDSCH; receive, from the BS, a PUCCH configuration for unicast; receive, from the BS, DCI scheduling a unicast PDSCH; determining a Type-1 HARQ-ACK codebook corresponding to the unicast PDSCH based on the first configuration for unicast SPS PDSCH, the second configuration for multicast SPS PDSCH, and the third configuration for unicast PDSCH; and transmit, to the BS, the Type-1 HARQ-ACK codebook corresponding to the unicast PDSCH in a first slot.

According to a third aspect of the present disclosure, a method for handling HARQ-ACK reception performed by a BS is provided. The method includes transmitting, to a UE, a first configuration for unicast SPS PDSCH, a second configuration for multicast SPS PDSCH, and a third configuration for unicast PDSCH; transmitting, to the UE, a PUCCH configuration for unicast; transmitting, to the UE, DCI scheduling a unicast PDSCH; and receiving, from the UE, a Type-1 HARQ-ACK codebook corresponding to the unicast PDSCH in a first slot, wherein the first configuration for unicast SPS PDSCH, the second configuration for multicast SPS PDSCH, and the third configuration for unicast PDSCH enable the UE to determine the Type-1 HARQ-ACK codebook corresponding to the unicast PDSCH.

According to a fourth aspect of the present disclosure, a BS for handling HARQ-ACK reception is provided. The BS includes one or more non-transitory computer-readable media having computer-executable instructions embodied therein; and at least one processor coupled to the one or more non-transitory computer-readable media, the at least one processor configured to execute the computer-executable instructions to cause the BS to transmit, to a UE, a first configuration for unicast SPS PDSCH, a second configuration for multicast SPS PDSCH, and a third configuration for unicast PDSCH; transmit, to the UE, a PUCCH configuration for unicast; transmit, to the UE, DCI scheduling a unicast PDSCH; and receive, from the UE, a Type-1 HARQ-ACK codebook corresponding to the unicast PDSCH in a first slot, wherein the first configuration for unicast SPS PDSCH, the second configuration for multicast SPS PDSCH, and the third configuration for unicast PDSCH enable the UE to determine the Type-1 HARQ-ACK codebook corresponding to the unicast PDSCH.

### BRIEF DESCRIPTION OF THE DRAWINGS

Aspects of the present disclosure are best understood from the following detailed description when read with the accompanying drawings. Various features are not drawn to scale. Dimensions of various features may be arbitrarily increased or reduced for clarity of discussion.

FIG. 1A illustrates a schematic diagram regarding determination of a Type-1 HARQ-ACK codebook associated with one HARQ-ACK feedback offset according to an example implementation of the present disclosure.

FIG. 1B illustrates a schematic diagram regarding determination of a Type-1 HARQ-ACK codebook associated with one HARQ-ACK feedback offset according to an example implementation of the present disclosure.

FIG. 2A illustrates a schematic diagram regarding determination of a Type-1 HARQ-ACK codebook associated with multiple HARQ-ACK feedback offsets according to an example implementation of the present disclosure.

FIG. 2B illustrates a schematic diagram regarding determination of a Type-1 HARQ-ACK codebook associated with multiple HARQ-ACK feedback offsets according to an example implementation of the present disclosure.

FIG. 3 is a flowchart illustrating a method for HARQ-ACK codebook transmission performed by a UE according to an example implementation of the present disclosure.

FIG. 4 is a flowchart illustrating a method for determining a Type-1 HARQ-ACK codebook corresponding to a unicast PDSCH based on a first configuration for unicast SPS PDSCH, a second configuration for multicast SPS PDSCH, and a third configuration for unicast PDSCH performed by a UE according to an example implementation of the present disclosure.

FIG. 5 is a flowchart illustrating a method for handling HARQ-ACK codebook reception performed by a BS according to an example implementation of the present disclosure.

FIG. 6 is a block diagram illustrating a node for wireless communication according to an example implementation of the present disclosure.

### DESCRIPTION

The acronyms in the present disclosure are defined as follows and unless otherwise specified, the acronyms have the following meanings:

| Abbreviation | Full name |
|---|---|
| 3GPP | 3^{rd} Generation Partnership Project |
| 5G | 5^{th} Generation |
| 5GC | 5G Core |
| ACK | Acknowledgment |
| ARQ | Automatic Repeat Request |
| BA | Bandwidth Adaptation |
| BS | Base Station |
| BSC | Base Station Controller |
| BWP | Bandwidth Part |
| C-RNTI | Common-Radio Network Temporary Identifier |
| CA | Carrier Aggregation |
| CFR | Common Frequency Resource |
| CN | Core Network |
| CORESET | Control Resource Set |
| CP | Cyclic Prefix |
| CQI | Channel Quality Indicator |
| CRC | Cyclic Redundancy Check |
| CS-RNTI | Configured Scheduling-Radio Network Temporary |
| | Identifier |
| CSI-RS | Channel State Information-Reference Signal |
| CSS | Common Search Space |
| DAI | Downlink Assignment Index |
| DC | Dual Connectivity |
| DCI | Downlink Control Information |
| DL | Downlink |
| E-UTRA(N) | Evolved Universal Terrestrial Radio Access (Network) |
| eMBB | enhanced Mobile Broadband |
| eNB | evolved Node B |
| EN-DC | E-UTRA NR Dual Connectivity |
| EPC | Evolved Packet Core |
| FEC | Forward Error Correction |
| G-RNTI | Group-Radio Network Temporary Identifier |
| gNB | Next-Generation Node B |
| GSM | Global System for Mobile communications |
| HARQ | Hybrid Automatic Repeat Request |
| HARQ-ACK | HARQ-Acknowledgment |
| ID | Identifier/Identity |
| IE | Information Element |
| LDPC | Low-Density Parity-Check |
| LTE | Long Term Evolution |
| LTE-A | LTE-Advanced |
| LSB | Least Significant Bit |
| MAC | Medium Access Control |
| MBS | Multicast Broadcast Service |
| MCG | Master Cell Group |
| MCS | Modulation and Coding Scheme |
| MCS-C-RNTI | MCS Common-Radio Network Temporary Identifier |
| MeNB | Master eNB |
| MIMO | Multiple Input Multiple Output |
| mMTC | massive Machine-Type Communication |
| MN | Master Node |
| MR-DC | Multi-RAT Dual Connectivity |
| MSB | Most Significant Bit |
| MSGB | Message B |
| NACK | Negative Acknowledgment |
| NB | Node B |
| NG | Next-Generation |
| ng-eNB | next-generation eNB |
| NGC | Next-Generation Core |
| NPN | Non-Public Network |
| NR | New Radio |
| OFDM | Orthogonal Frequency-Division Multiplexing |
| P-RNTI | Paging-Radio Network Temporary Identifier |
| PBCH | Physical Broadcast Channel |
| PCell | Primary Cell |
| PDCCH | Physical Downlink Control Channel |
| PDSCH | Physical Downlink Shared Channel |
| PLMN | Public Land Mobile Network |
| PMI | Precoding Matrix Index |
| PRACH | Physical Random Access Channel |
| PRB | Physical Resource Block |
| ProSe | Proximity Service |
| PSCell | Primary Secondary Cell/Primary SCG Cell |
| PUCCH | Physical Uplink Control Channel |
| RA-RNTI | Random Access-Radio Network Temporary Identifier |
| RAN | Radio Access Network |
| RAT | Radio Access Technology |
| RB | Radio Bearer |
| Rel-15 | 3GPP Release 15 |
| Rel-16 | 3GPP Release 16 |
| Rel-17 | 3GPP Release 17 |
| RI | Rank Index |
| RNC | Radio Network Controller |
| RNTI | Radio Network Temporary Identifier |
| RRC | Radio Resource Control |
| RS | Reference Signal |
| SCell | Secondary Cell |
| SCG | Secondary Cell Group |
| SCS | Sub-Carrier Spacing |
| SFN | System Frame Number |
| SgNB | Secondary gNB |
| SI | System Information |
| SIB | System Information Block |
| SIB1 | System Information Block Type 1 |
| SL | SideLink |
| SLIV | Start and Length Indicator |
| SN | Secondary Node |
| SNPN | Stand-Alone Non-Public Network |
| SpCell | Special Cell |
| SR | Scheduling Request |
| SS | Synchronization Signal |
| SUL | Supplementary Uplink |
| TA | Timing Advance/Time Alignment |
| TB | Transport Block |
| TPC | Transmit Power Control |
| TS | Technical Specification |
| UE | User Equipment |
| UL | Uplink |
| UMTS | Universal Mobile Telecommunications System |
| URLLC | Ultra-Reliable Low-Latency Communication |
| USS | UE-specific Search Space |
| UTRAN | Universal Terrestrial Radio Access Network |
| V2X | Vehicle-to-Everything |
| VRB | Virtual Resource Block |
| WI | Working Item |

The following contains specific information related to example implementations of the present disclosure. The drawings and their accompanying detailed description are merely directed to example implementations. However, the present disclosure is not limited to these example implementations. Other variations and implementations of the present disclosure will be obvious to those skilled in the art.

Unless noted otherwise, like or corresponding elements among the drawings may be indicated by like or corresponding reference designators. Moreover, the drawings and illustrations in the present disclosure are generally not to scale, and are not intended to correspond to actual relative dimensions.

For the purpose of consistency and ease of understanding, like features may be identified (although, in some examples, not illustrated) by the same reference designators in the drawings. However, the features in different implementations may differ in other respects and shall not be narrowly confined to the implementations illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for disclosing associated objects and represents that three relationships may exist such that A and/or B may indicate that A exists alone, A and B exist at the same time, or B exists alone. “A and/or B and/or C” may represent that at least one of A, B, and C exists. The character “/” generally represents that the associated objects are in an “or” relationship.

The terms “if”, “in a case that”, “while”, “when”, “after”, “upon”, and “once” may be used interchangeably. The terms “according to”, “based on”, “through”, and “via” may be used interchangeably.

The terms “determine”, “decide”, and “select” may be used interchangeably. The terms “determined”, “defined”, “configured”, “given”, “predetermined”, “predefined”, “preconfigured”, and “pre-given” may be used interchangeably. The terms “operate”, “implement”, and “perform” may be used interchangeably.

For the purposes of explanation and non-limitation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuitry (ASIC), programmable logic arrays, and/or using one or more Digital Signal Processors (DSPs). Although some of the disclosed implementations are oriented to software installed and executing on computer hardware, alternative example implementations implemented as firmware or as hardware or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as an LTE system, an LTE-A system, an LTE-Advanced Pro system, or a 5G NR RAN may typically include at least one BS, at least one UE, and one or more optional network elements that provide connection within a network. The UE may communicate with the network such as a CN, an EPC network, an E-UTRAN, an NGC, a 5GC, or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least an RAT such as Worldwide Interoperability for Microwave Access (WiMAX), Global System for Mobile communications (GSM that is often referred to as 2G), GSM Enhanced Data rates for GSM Evolution (EDGE) RAN (GERAN), General Packet Radio Service (GPRS), Universal Mobile Telecommunication System (UMTS that is often referred to as 3G) based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, an NB in the UMTS, an eNB in LTE or LTE-A, an RNC in UMTS, a BSC in the GSM/GERAN, an ng-eNB in an E-UTRA BS in connection with 5GC, a gNB in the 5G-RAN (or in the 5G Access Network (5G-AN)), or any other apparatus capable of controlling radio communication and managing radio resources within a cell. The BS may serve one or more UEs via a radio interface.

The BS may be operable to provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate SL resources for supporting ProSe, LTE SL services, and/or LTE/NR V2X services. Each cell may have overlapped coverage areas with other cells.

In MR-DC cases, the primary cell of an MCG or an SCG may be called an SpCell. A PCell may refer to the SpCell of an MCG. A PSCell may refer to the SpCell of an SCG. An MCG may refer to a group of serving cells associated with the MN, comprising the SpCell and optionally one or more SCells. An SCG may refer to a group of serving cells associated with the SN, comprising the SpCell and optionally one or more SCells.

As disclosed above, the frame structure for NR supports flexible configurations for accommodating various next-generation (e.g., 5G) communication requirements such as eMBB, mMTC, and URLLC, while fulfilling high reliability, high data rate and low latency requirements. The OFDM technology in the 3GPP may serve as a baseline for an NR waveform. The scalable OFDM numerology such as adaptive sub-carrier spacing, channel bandwidth, and CP may also be used.

Two coding schemes are considered for NR, specifically LDPC code and Polar Code. The coding scheme adaption may be configured based on channel conditions and/or service applications.

At least DL transmission data, a guard period, and an UL transmission data should be included in a transmission time interval (TTI) of a single NR frame. The respective portions of the DL transmission data, the guard period, and the UL transmission data should also be configurable (e.g., based on the network dynamics of NR). SL resources may also be provided in an NR frame to support ProSe services, V2X services (e.g., E-UTRA V2X SL communication services) or SL services (e.g., NR SL communication services). In contrast, SL resources may also be provided in an E-UTRA frame to support ProSe services, V2X services (e.g., E-UTRA V2X SL communication services) or SL services (e.g., NR SL communication services).

Multiple PLMNs may operate on an unlicensed spectrum. Multiple PLMNs may share the same unlicensed carrier. The PLMNs may be public or private. Public PLMNs may be (but not limited to) operators or virtual operators, which provide radio services to public subscribers. Public PLMNs may own a licensed spectrum and support an RAT on the licensed spectrum as well. Private PLMNs may be (but not limited to) micro-operators, factories, or enterprises, which provide radio services to its private users (e.g., employees or machines). Public PLMNs may support more deployment scenarios (e.g., CA between licensed band NR (PCell) and NR-Unlicensed (NR-U) (SCell), DC between licensed band LTE (PCell) and NR-U (PSCell), stand-alone NR-U, an NR cell with DL in an unlicensed band and UL in a licensed band, DC between licensed band NR (PCell) and NR-U (PSCell)). Private PLMNs may support (but not limited to) stand-alone unlicensed RAT (e.g., stand-alone NR-U).

Any two or more than two of the following sentences, paragraphs, (sub)-bullets, points, actions, behaviors, terms, alternatives, aspects, examples, or claims described in the following disclosure may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency (e.g., “based on”, “more specifically”, “preferably”, “In one embodiment”, “In some implementations”, “In one alternative”, “In one example”, “In one aspect”, or etc.) in the following disclosure is just one possible example which would not restrict the specific method.

Example description of some selected terms, examples, embodiments, implementations, actions, and/or behaviors used in the present disclosure are given as follows.

The terms “network”, “RAN”, “cell”, “camped cell”, “serving cell”, “BS”, “gNB”, “eNB” and “ng-eNB” may be used interchangeably. In some implementations, some of these items may refer to the same network entity.

Cell: A cell may be a radio network object that can be uniquely identified by a UE from a (cell) identification that is broadcast over a geographical area from one UTRAN Access Point. The Cell may be either FDD or TDD mode.

Serving cell: For a UE in an RRC connected state (e.g., RRC_CONNECTED state) not configured with CA or DC, there may be only one serving cell, which may be referred to as a PCell. For a UE in RRC_CONNECTED state configured with CA or DC, the term “serving cells” may be used to denote a set of cells comprising SpCell(s) and all SCells. For example, the serving cell may be a PCell, a PSCell, or an SCell described in the TS 38.331.

A UE (operating) in RRC_CONNECTED state may refer to an RRC_CONNECTED UE. A UE (operating) in an RRC idle state (e.g., RRC_IDLE state) may refer to an RRC_IDLE UE. A UE (operating) in an RRC inactive state (e.g., RRC_INACTIVE state) may refer to an RRC_INACTIVE UE.

SpCell: For DC operation, the term SpCell may refer to a PCell of an MCG or a PSCell of an SCG. Otherwise, the term SpCell may refer to the PCell.

MR-DC: An MR-DC may be DC between E-UTRA and NR nodes, or between two NR nodes. The MR-DC may include EN-DC, NR-E-UTRA Dual Connectivity (NE-DC), NG-RAN E-UTRA-NR Dual Connectivity (NGEN-DC), and NR-NR Dual Connectivity (NR-DC) (mode).

MCG: An MCG may be, in MR-DC, a group of serving cells associated with an MN comprising an SpCell (e.g., PCell) and optionally one or more SCells.

MN: An MN may be, in MR-DC, a radio access node that provides a control plane connection to a CN. The MN may be a Master eNB (in EN-DC), a Master ng-eNB (in NGEN-DC), or a Master gNB (in NR-DC and NE-DC).

SCG: An SCG may be, in MR-DC, a group of serving cells associated with an SN comprising an SpCell (e.g., PSCell) and optionally one or more SCells.

SN: An SN may be, in MR-DC, a radio access node, with no control plane connection to a CN, providing additional resources to a UE. The SN may be an en-gNB (in EN-DC), a Secondary ng-eNB (in NE-DC), or a Secondary gNB (in NR-DC and NGEN-DC).

MeNB: An MeNB may be an eNB as a master node associated with an MCG in MR-DC (scenarios).

SgNB: An SgNB may be a gNB as a secondary node associated with an SCG in MR-DC (scenarios).

BWP: In some implementations, a BWP may be a subset of the total cell bandwidth of a cell. By configuring one or more BWPs to the UE and informing the UE that which of the configured BWPs is the currently the active BWP, BA may be achieved. To enable BA mechanism on the PCell, the gNB may configure the UE with one or more UL and DL BWPs. In case of CA, to enable the BA mechanism on Scell(s), the gNB may configure the UE with one or more DL BWPs at least (which means that there may be no UL BWPs configured to the UE). For the PCell, the initial BWP may be the BWP used for initial access. For the SCell(s), the initial BWP may be the BWP configured for the UE to first operate during the SCell activation process. In some implementations, the UE may be configured with a first active UL BWP by a “firstActiveUplinkBWP” IE/field. If the first active UL BWP is configured for an SpCell, the “firstActiveUplinkBWP” IE/field may include the ID of the UL BWP to be activated when the RRC (re)configuration is performed. If the field is absent, the RRC (re)configuration may not trigger a BWP switch. If the first active UL BWP is configured for an SCell, the “firstActiveUplinkBWP” IE/field may include the ID of the UL BWP to be used upon the MAC-activation of the SCell.

HARQ-ACK: In some implementations, an HARQ may be a scheme that combines an ARQ error control mechanism and an FEC coding in which unsuccessful attempts are used in FEC decoding instead of being discarded. In some implementations, HARQ-ACK feedback may be used to indicate whether a HARQ process is successfully performed.

CSI: In some implementations, CSI may include CQIs as well as MIMO-related feedback. The MIMO-related feedback may include RIs and PMI, etc.

SR: In some implementations, an SR may be used by a UE to request UL resource(s).

### PUCCH Overriding Timeline (Constraint)

In some implementations, if a UE detects a first DCI format indicating a first resource for PUCCH transmission with corresponding HARQ-ACK information in a slot and also detects (e.g., at a later time) a second DCI format indicating a second resource for PUCCH transmission with corresponding HARQ-ACK information in the slot, the UE may not (expect to) multiplex the HARQ-ACK information corresponding to the second DCI format in a PUCCH resource in the slot if the PDCCH reception that includes the second DCI format is not earlier than a specific time duration from the beginning (or start) of a first symbol of the first resource for the PUCCH transmission in the slot. The specific time duration may be N₃·(2048+144)·κ·2^{-μ}·T_{C}·κ, μ, and T_{C} may be described in TS 38 series specifications. For example, κ and T_{C} may be defined in TS 38.211. μ may correspond to the smallest SCS configuration among the SCS configurations of the PDCCHs providing the DCI formats and the SCS configuration of the PUCCH. If processingType2Enabled of PDSCH-ServingCellConfig is set to enable for the serving cell with the second DCI format and for all serving cells with corresponding HARQ-ACK information multiplexed in the PUCCH transmission in the slot, N₃=3 for μ=0, N₃=4.5 for μ=1, and N₃=9 for μ=2; otherwise, N₃=8 for μ=0, N₃=10 for μ=1, N₃=17 for μ=2, and N₃=20 for μ=3.

### UCI Multiplexing Timeline (Constraint)

In some implementations, if a UE attempts to transmit a group of overlapping PUCCHs (e.g., PUCCHs overlapping each other) in a slot or overlapping PUCCH(s) and PUSCH(s) in a slot, the UE is configured to multiplex different UCI types in one PUCCH, and at least one of the overlapping PUCCH(s) or PUSCH(s) is in response to a DCI format detection by the UE, the UE may multiplex all corresponding UCI types if the following conditions are met.

If one of the PUCCH transmissions or PUSCH transmissions is in response to a DCI format detection by the UE, the UE may expect that the first symbol S₀ of the earliest PUCCH or PUSCH, among a group of overlapping PUCCH(s) and PUSCH(s) (e.g., PUCCH(s) overlapping PUSCH(s)) in the slot, satisfies at least one of the following timeline conditions.

Condition: S₀ is not before a symbol with a CP starting after T_{proc,1}^{mux} after a last symbol of any corresponding PDSCH. T_{proc,1}^{mux} is given by the maximum of {T_{proc,1}^{mux,1}, T_{proc,1}^{mux,i}, . . . }. For the i-th PDSCH with corresponding HARQ-ACK transmission on a PUCCH which is in the group of overlapping PUCCH(s) and PUSCH(s), T_{proc,1}^{mux,i}=(N₁+d_{1,1}+1)·(2048+144)·κ·2^{-μ}·T_{C}. N₁, d_{1,1}, κ, μ, and T_{C} may be defined TS 38 series specifications (e.g., TS 38.211, TS 38.214). For example, d_{1,1} may be selected for the i-th PDSCH. N₁ may be selected based on the UE PDSCH processing capability of the i-th PDSCH and SCS configuration μ. μ may correspond to the smallest SCS configuration among the SCS configurations used for the PDCCH scheduling the i-th PDSCH, the i-th PDSCH, the PUCCH with corresponding HARQ-ACK transmission for i-th PDSCH, and all PUSCHs in the group of overlapping PUCCH(s) and PUSCH(s).

Condition: S₀ is not before a symbol with a CP starting after T_{proc,release}^{mux} after a last symbol of any corresponding SPS PDSCH release. T_{proc,release}^{mux} is given by the maximum of {T_{proc,release}^{mux,1}, . . . , T_{proc,release}^{mux,i}, . . . }. For the i-th PDCCH providing the SPS PDSCH release with corresponding HARQ-ACK transmission on a PUCCH which is in the group of overlapping PUCCH(s) and PUSCH(s), T_{proc,release}^{mux,i}=(N+1)·(2048+144)·κ·2^{-μ}·T_{C}. N, κ, μ, and T_{C} may be defined TS 38 series specifications (e.g., TS 38.211, TS 38.214). For example, N may be selected based on the UE PDSCH processing capability of the i-th SPS PDSCH release and SCS configuration μ. μ may correspond to the smallest SCS configuration among the SCS configurations used for the PDCCH providing the i-th SPS PDSCH release, the PUCCH with corresponding HARQ-ACK transmission for i-th SPS PDSCH release, and all PUSCHs in the group of overlapping PUCCH(s) and PUSCH(s).

Condition: if there is no aperiodic CSI report multiplexed in a PUSCH in the group of overlapping PUCCH(s) and PUSCH(s), S₀ is not before a symbol with a CP starting after T_{proc,2}^{mux} after a last symbol of:
any PDCCH with the DCI format scheduling an overlapping PUSCH, and
any PDCCH scheduling a PDSCH (or SPS PDSCH release) with corresponding HARQ-ACK information in an overlapping PUCCH in the slot

If there is at least one PUSCH in the group of overlapping PUCCH(s) and PUSCH(s), T_{proc,2}^{mux} is given by the maximum of {T_{proc,2}^{mux,1}, . . . , T_{proc,2}^{mux,i}}. For the i-th PUSCH which is in the group of overlapping PUCCH(s) and PUSCH(s), T_{proc,2}^{mux,i}=max(d_{2,2}, (N₂+d_{2,1}+1)·(2048+144)·κ·2^{-μ}·T_{C}). N₂, d_{2,1}, d_{2,2}, κ, μ, and T_{C} may be defined TS 38 series specifications (e.g., TS 38.211, TS 38.214). For example, d_{2,1} and d_{2,2} may be selected for the i-th PUSCH. N₂ may be selected based on the UE PUSCH processing capability of the i-th PUSCH and SCS configuration μ. μ may correspond to the smallest SCS configuration among the SCS configurations used for the PDCCH scheduling the i-th PUSCH, the PDCCHs scheduling the PDSCHs with corresponding HARQ-ACK transmission on a PUCCH which is in the group of overlapping PUCCH(s) and PUSCH(s), and all PUSCHs in the group of overlapping PUCCH(s) and PUSCH(s).

If there is no PUSCH in the group of overlapping PUCCH(s) and PUSCH(s), T_{proc,2}^{mux} is given by the maximum of {T_{proc,2}^{mux,1}, . . . , T_{proc,2}^{mux,i}, . . . }. For the i-th PDSCH with corresponding HARQ-ACK transmission on a PUCCH which is in the group of overlapping PUCCHs, T_{proc,2}^{mux,i}=(N₂+1)·(2048+144)·κ·2^{-μ}·T_{C}. N₂, κ, μ, and T_{C} may be defined TS 38 series specifications (e.g., TS 38.211, TS 38.214). For example, N₂ may be selected based on the UE PUSCH processing capability of the PUCCH serving cell if configured. N₂ may be selected based on the UE PUSCH processing capability 1, if PUSCH processing capability is not configured for the PUCCH serving cell. μ may be selected based on the smallest SCS configuration between the SCS configuration used for the PDCCH scheduling the i-th PDSCH with corresponding HARQ-ACK transmission on a PUCCH which is in the group of overlapping PUCCHs, and the SCS configuration for the PUCCH serving cell.

Condition: if there is an aperiodic CSI report multiplexed in a PUSCH in the group of overlapping PUCCH(s) and PUSCH(s), S₀ is not before a symbol with a CP starting after T_{proc,CSI}^{mux}=max(d_{2,2}, (Z+d)·(2048+144)·κ·2^{-μ}·T_{C}) after a last symbol of
any PDCCH with the DCI format scheduling an overlapping PUSCH, and
any PDCCH scheduling a PDSCH (or SPS PDSCH release) with corresponding HARQ-ACK information in an overlapping PUCCH in the slot

d_{2,2}, Z, d, κ, μ, and T_{C} may be defined TS 38 series specifications (e.g., TS 38.211, TS 38.214). For example, y may correspond to the smallest SCS configuration among the SCS configuration of the PDCCHs, the smallest SCS configuration for the group of the overlapping PUSCHs, and the smallest SCS configuration of CSI-RS associated with the DCI format scheduling the PUSCH with the multiplexed aperiodic CSI report. d=2 for μ=0, 1, d=3 for μ=2, and d=4 for μ=3.

N₁, N₂, d_{1,1}, d_{2,1}, and Z may be defined TS 38 series specifications (e.g., TS 38.211, TS 38.214).

### Determination of PUCCH Resource and the Total Number of PRBs

In some implementations, if a UE has HARQ-ACK, SR and wideband or sub-band CSI reports to transmit and the UE determines a PUCCH resource with PUCCH format 2, or the UE has HARQ-ACK, SR and wideband CSI reports to transmit and the UE determines a PUCCH resource with PUCCH format 3 or PUCCH format 4, where:
the UE determines the PUCCH resource using the PUCCH resource indicator field in a last of a number of DCI formats with a value of a PDSCH-to-HARQ_feedback timing indicator field, if present, or a value of dl-DataToUL-ACK, or a value of dl-DataToUL-ACKForDCIFormat1_2 for DCI format 1_2, indicating a same slot for the PUCCH transmission, from a PUCCH resource set provided to the UE for HARQ-ACK transmission,
the UE determines the PUCCH resource set as described in Clause 9.2.1 and Clause 9.2.3 for O_{UCI} UCI bits, and:
if (O_{ACK}+O_{SR}+O_{CSI-part1}+O_{CRC,CSI-part1})≤M_{RB}^{PUCCH}·N_{sc,ctrl}^{RB}·N_{symb-UCI}^{PUCCH}·Qₘ·r, the UE may transmit the HARQ-ACK, SR, and CSI reports bits by selecting the minimum number M_{RB,min}^{PUCCH} of the M_{RB}^{PUCCH} PRBs satisfying (O_{ACK}+O_{SR}+O_{CSI-part1}+O_{CRC,CSI-part1})≤M_{RB,min}^{PUCCH}·N_{sc,ctrl}^{RB}·N_{symb-UCI}^{PUCCH}·Qₘ·r (as described in TS 38 series specifications);
else, the UE may select N_{CSI}^{reported} CSI report(s), from the N_{CSI}^{total} CSI reports, for transmission together with HARQ-ACK and SR in ascending priority value, where the value of N_{CSI}^{reported} satisfies

$$( {O}_{A C K} + {O}_{S R} + {\sum }_{n = 1}^{{N}_{CSI}^{reported}} {O}_{C S I - p a r t 1 , n} + {O}_{C R C , C S I - p a r t 1 , N} ) \leq {M}_{R B}^{P U C C H} \cdot {N}_{sc , ctr l}^{R B} \cdot {N}_{s y m b - U C I}^{P U C C H} \cdot {Q}_{m} \cdot r$$

$$and$$

$$( {O}_{A C K} + {O}_{S R} + {\sum }_{n = 1}^{{N}_{C S I}^{reported} + 1} {O}_{C S I - p a r t 1 , n} + {O}_{C R C , C S I - p a r t 1 , N + 1} ) > {M}_{R B}^{P U C C H} \cdot {N}_{sc , ctrl}^{R B} \cdot {N}_{s y m b - U C I}^{P U C C H} \cdot {Q}_{m} \cdot r ,$$

where O_{CSI-part1,n} is a number of CRC bits corresponding to

$${O}_{A C K} + {O}_{S R} + {\sum }_{n = 1}^{{N}_{CSI}^{reported}} {O}_{C S I - p a r t 1 , n} \qquad UCI bits ,$$

and O_{CRC,CSI-part1,N+1} is a number of CRC bits corresponding to

$${O}_{A C K} + {O}_{S R} + {\sum }_{n = 1}^{{N}_{CSI}^{reported} + 1} {O}_{C S I - p a r t 1 , n} \qquad UCI bits .$$

In some implementations, if a UE has HARQ-ACK, SR and sub-band CSI reports to transmit and the UE determines a PUCCH resource with PUCCH format 3 or PUCCH format 4, where:
the UE determines the PUCCH resource using the PUCCH resource indicator field in a last of a number of DCI formats with a value of a PDSCH-to-HARQ_feedback timing indicator field indicating a same slot for the PUCCH transmission, from a PUCCH resource set provided to the UE for HARQ-ACK transmission,
the UE determines the PUCCH resource set as described in Clause 9.2.1 and Clause 9.2.3 for O_{UCI} UCI bits, and:
if (O_{ACK}+O_{SR}+O_{CSI}+O_{CRC})≤M_{RB}^{PCCH}·N_{sc,ctrl}^{RB}·N_{symb-UCI}^{PUCCH}·Qₘ·r, the UE may transmit the HARQ-ACK, SR and the N_{CSI}^{total} CSI report bits by selecting the minimum number M_{RB,min}^{PUCCH} of PRBs from the M_{RB}^{PUCCH} PRBs satisfying (O_{ACK}+O_{SR}+O_{CSI}+O_{CRC})≤M_{RB,min}^{PUCCH}·N_{sc,ctrl}^{RB}·N_{symb-UCI}^{PUCCH}·Qₘ·r (as described in TS 38 series specifications);
if (O_{ACK}+O_{SR}+O_{CSI}+O_{CRC})>M_{RB}^{PUCCH}·N_{sc,ctrl}^{RB}·N_{symb-UCI}^{PUCCH}·Qₘ·r and if for N_{CSI-part2}^{reported}>0 Part 2 CSI report priority value(s), it is

$${\sum }_{n = 1}^{{N}_{C S I - part 2}^{reported}} {O}_{C S I - p a r t 2 , n} + {O}_{C R C , C S I - p a r t 2 , N} \leq ( {M}_{R B}^{P U C C H} \cdot {N}_{sc , ctrl}^{R B} \cdot {N}_{symb - UCI}^{P UCCH} - ⌈ ( {O}_{A C K} + {O}_{S R} + {\sum }_{n = 1}^{{N}_{CSI}^{total}} {O}_{C S I - p a r t 1 , n} + {O}_{C R C , C S I - p a r t 1} ) / ( {Q}_{m} \cdot r ) ⌉ ) \cdot {Q}_{m} \cdot r$$

$$and$$

$${\sum }_{n = 1}^{{N}_{C S I - part 2}^{reported} + 1} {O}_{C S I - p a r t 2 , n} + {O}_{CRC , CSI - part 2 , N + 1} > ( {M}_{R B}^{P U C C H} \cdot {N}_{sc , ctrl}^{R B} \cdot {N}_{symb - UCI}^{P UCCH} - ⌈ ( {O}_{A C K} + {O}_{S R} + {\sum }_{n = 1}^{{N}_{CSI}^{total}} {O}_{C S I - p a r t 1 , n} + {O}_{C R C , C S I - p a r t 1} ) / ( {Q}_{m} \cdot r ) ⌉ ) \cdot {Q}_{m} \cdot r ,$$

the UE may select the first N_{CSI-part2}^{reported} Part 2 CSI reports, according to respective priority value(s), for transmission together with the HARQ-ACK, SR and N_{CSI}^{total} Part 1 CSI reports, where O_{CSI-part1,n} is the number of Part 1 CSI report bits for the nₜₕ CSI report and O_{CSI-part2,n} is the number of Part 2 CSI report bits for the nₜₕ CSI report priority value, O_{CRC,CSI-part2,N} is a number of CRC bits corresponding to

$${\sum }_{n = 1}^{{N}_{C S I - part 2}^{reported}} {O}_{C S I - p a r t 2 , n} ,$$

and O_{CRC,CSI-part2,N+1} is a number of CRC bits corresponding to

$${\sum }_{n = 1}^{{N}_{C S I - part 2}^{reported} + 1} {O}_{C S I - p a r t 2 , n} ;$$

if (O_{ACK}+O_{SR}+O_{CSI}+O_{CRC})>M_{RB}^{PUCCH}·N_{sc,ctrl}^{RB}·N_{symb-UCI}^{PUCCH}·Qₘ·r and if for N_{CSI-part2}^{reported}<0 Part 2 CSI report priority value(s), the UE may drop all Part 2 CSI reports and select N_{CSI-part1}^{reported} Part 1 CSI report(s), from the N_{CSI}^{total} CSI reports in ascending priority value, for transmission together with the HARQ-ACK and SR information bits where the value of N_{CSI-part1}^{reported} satisfies

$$( {O}_{A C K} + {O}_{S R} + {\sum }_{n = 1}^{{N}_{C S I - part 1}^{reported}} {O}_{C S I - p a r t 1 , n} + {O}_{C R C , C S I - p a r t 1 , N} ) \leq {M}_{R B}^{P U C C H} \cdot {N}_{s c , ′ c t r 1}^{R B} \cdot {N}_{s y m b - U C I}^{P U C C H} \cdot {Q}_{m} \cdot r$$

$$and$$

$$( {O}_{A C K} + {O}_{S R} + {\sum }_{n = 1}^{{N}_{C S I - part 1}^{reported} + 1} {O}_{C S I - p a r t 1 , n} + {O}_{C R C , C S I - p a r t 1 , N + 1} ) > {M}_{R B}^{P U C C H} \cdot {N}_{sc , ctrl}^{R B} \cdot {N}_{s y m b - U C I}^{P U C C H} \cdot {Q}_{m} \cdot r ,$$

where O_{CRC,CSI-part1,N} is a number of CRC bits corresponding to

$${O}_{A C K} + {O}_{S R} + {\sum }_{n = 1}^{{N}_{C S I - part 1}^{reported}} {O}_{C S I - p a r t 1 , n} \qquad UCI bits ,$$

and O_{CRC,CSI-part1,N+1} is a number of CRC bits corresponding to

$${O}_{A C K} + {O}_{S R} + {\sum }_{n = 1}^{{N}_{C S I - part 1}^{reported} + 1} {O}_{C S I - p a r t 1 , n} \qquad UCI bits .$$

SI may refer to MIB, SIB1, and other SI. Minimum SI may include MIB and SIB1. Other SI may refer to SIB3, SIB4, SIB5, and other SIB(s) (e.g., SNPN-specific SIB, PNI-NPN-specific SIB).

Dedicated signaling may refer to (but not limited to) RRC message(s). For example, the RRC message(s) may include an RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message. RRC message may be one kind of dedicated signaling. The UE may receive the RRC message from the network via unicast/broadcast/groupcast.

The disclosed mechanism may be applied to any RAT. The RAT may be (but not limited to) NR, NR-U, LTE, E-UTRA connected to 5GC, LTE connected to 5GC, E-UTRA connected to EPC, and LTE connected to EPC. The disclosed mechanism may be applied for UEs in public networks, or in private networks (e.g., NPN, SNPN, and PNI-NPN).

The disclosed mechanism may be used for licensed frequency and/or unlicensed frequency.

Generally, the disclosed mechanisms may be (but not limited to) applied for the PCell and the UE. In addition, the mechanisms described in the present disclosure may be applied for the PSCell and the UE.

In the present disclosure, the terms “IE” and “field” may be used interchangeably. The terms “semi-static HARQ-ACK codebook” and “Type-1 HARQ-ACK codebook” may be used interchangeably. The terms “dynamic HARQ-ACK codebook” and “Type-2 HARQ-ACK codebook” may be used interchangeably.

In Rel-15 and Rel-16 NR, the features of broadcast and multicast supported in NR have not been specified. Considering that broadcast and/or multicast could provide substantial improvements for important use cases, especially in regard to system efficiency and user experience, it is beneficial to enable broadcast and/or multicast services (e.g., general MBS services) over 5GS. The uses cases that may benefit from this feature include public safety, mission critical, and V2X applications, etc. In 3GPP RAN #88-e, a new WI MBS was agreed with an objective of improving reliability of the broadcast and/or multicast services (e.g., by using UL feedbacks) for UEs in RRC_CONNECTED state.

In some implementations, the broadcast and/or multicast services may be provided to a group of UEs via dynamic PDSCH(s) or SPS PDSCH(s). To provide the broadcast and/or multicast services, a gNB may schedule a group common PDSCH that is receivable for the group of UEs via a group common PDCCH that is receivable for the group of UEs. In some other implementations, the gNB may separately schedule a unicast PDSCH that is receivable for each UE of the group of UEs via a dedicated PDCCH that is receivable for each UE of the group of UEs. In some other implementations, the gNB may schedule the group common PDSCH that is receivable for the group of UEs via a separate dedicated PDCCH that is receivable for each UE of the group of UEs. Using the group common PDCCH or the group common PDSCH has the benefit of resource efficiency, since the same information only needs to be transmitted once. On the other hand, using the dedicated PDCCH or the dedicated PDSCH has the benefit of scheduling flexibility, since the gNB can schedule a specific UE based on a UE capability and channel condition(s) for the specific UE.

In some implementations, a narrow beam or more accurate precoding may be used for the dedicated PDCCH or the dedicated PDSCH. Combined usage of the implementations may also be beneficial. For example, resource efficiency may be improved when the gNB schedules the group common PDSCH via the group common PDCCH for the group of UEs except for some UEs with relatively worse channel condition compared to other UEs of the group of UEs, since MCSs of the group common PDCCH and group common PDSCH may not need to be selected based on the worse channel condition.

To improve reliability of group common PDSCH(s), HARQ retransmission may be enabled. Accordingly, HARQ-ACK feedback(s) from a group of UEs receiving the group common PDSCH(s) may (needed to) indicate a gNB whether the HARQ retransmission is needed. Without the HARQ-ACK feedback(s), the gNB may perform blind HARQ retransmission, which is not (resource) efficient since it is not needed when all UEs of the group of UEs successfully receive the group common PDSCH(s).

Two types of HARQ-ACK feedbacks may be used for the group common PDSCH(s). The first type is an ACK/NACK based HARQ-ACK feedback. Different PUCCH resources for different UEs may (be required to) carry the HARQ-ACK feedback (e.g., ACK or NACK). The gNB may schedule the HARQ retransmission via a group common PDSCH or via a dedicated PDSCH based on whether there are UEs feedbacking NACK and how many UEs feedbacking the NACK. The gNB may (determine to) schedule the HARQ retransmission to a UE via the dedicated PDSCH (only) if the UE feedbacking NACK or if the UE has worse channel condition.

The second type is a NACK-only based HARQ-ACK feedback. A PUCCH resource that is shared by the group of UEs may (only) be required. For the shared PUCCH resource, the gNB may (only) know that at least one UE of the group of UEs does not successfully receive the group common PDSCH(s) when the gNB detects a PUCCH, but the gNB may not determine which UE(s) transmits the PUCCH. The gNB may schedule the HARQ retransmission via the group common PDSCH(s) if the gNB detected the PUCCH.

PUCCH resource(s) for HARQ-ACK feedback for a group common PDSCH may be configured in “PUCCH-ConfigurationList” that is different from “PUCCH-ConfigurationList”that is used for configuration of PUCCH resource(s) for HARQ-ACK feedback for dedicated PDSCH, CSI, and SR. In other words, the UE may be configured with two PUCCH-ConfigurationList, each may include up to two PUCCH-Config. The first PUCCH-Config in “PUCCH-ConfigurationList” may include configuration(s) of PUCCH resources with lower physical layer priority. The second PUCCH-Config in the PUCCH-ConfigurationList may include configuration(s) of PUCCH resources with higher physical layer priority. The PUCCH-ConfigurationList for group common PDSCH may be configured as part of a CFR configuration or may be configured together with the other PUCCH-ConfigurationList that is used for dedicated PDSCH, CSI, and SR.

In the present disclosure, PUCCH resource(s) configured by “PUCCH-ConfigurationList” for group common PDSCH may be referred to as multicast PUCCH(s). PUCCH resource(s) configured by “PUCCH-ConfigurationList” for dedicated PDSCH, CSI, and SR may be referred to as unicast PUCCH(s). In addition, dedicated PDCCH(s) and dedicated PDSCH(s) may be referred to as unicast PDCCH(s) and unicast PDSCH(s), respectively.

For the CFR configuration, a separate PDCCH-Config and a separate PDSCH-Config different from those in a dedicated BWP configuration may be provided by the gNB.

A group common PDCCH may be transmitted in a search space configured for a group of UEs. The search space may be a Type 3 CSS or a Type 4 CSS based on the configuration in PDCCH-Config associated with the CFR. The group common PDCCH may include a specific DCI format configured or defined for the group common PDCCH. For example, the DCI format may be a DCI format 1_0 with CRC scrambled by G-RNTI, a DCI format 1_1, or a DCI format 1_2 with CRC scrambled by G-RNTI. Alternatively, the DCI format may be a new DCI format (e.g., DCI format 1_3).

In Rel-15 NR, different PUCCHs may be configured with different starting symbols in a slot. PUSCHs may also be scheduled (or configured) with different starting symbols in the slot. A set of PUCCH resources may be defined and a (UCI) multiplexing procedure may perform the following steps iteratively on the set of PUCCH resources. It should be noted that the set of PUCCH resources may be referred to as a (PUCCH resource) set Q.

To determine (e.g., define) the set of PUCCH resources, the UE may determine up to two CSI PUCCH resources in the slot with highest CSI priorities and at most one CSI PUCCH resource being PUCCH format 3 or PUCCH format 4 when there are overlapping CSI PUCCH resources in the slot and when multi-CSI-PUCCH-ResourceList is not configured or when there are no overlapping CSI PUCCH resources in the slot and when the multi-CSI-PUCCH-ResourceList is configured. The UE may determine (e.g., select), from the multi-CSI-PUCCH-ResourceList, a PUCCH resource in which all CSIs of the CSI PUCCH resources in the slot are multiplexed when there are overlapping CSI PUCCH resources in the slot and when the multi-CSI-PUCCH-ResourceList is configured. Up to two CSI PUCCH resources may be included in the set of PUCCH resources as described above.

If a PUCCH for HARQ-ACK is scheduled in the slot, the PUCCH resource for the HARQ-ACK to be included in the set of PUCCH resources may be determined as the PUCCH resource selected from a PUCCH resource set based on PRI in the scheduling DCI. The PUCCH resource set may be determined based on a payload size of the HARQ-ACK. If a SPS HARQ-ACK PUCCH resource is configured in the slot, it may be included in the set of PUCCH resources. If an SR PUCCH resource is with negative SR and does not overlap any of the CSI PUCCH resources, the HARQ-ACK PUCCH resource, or the SPS HARQ-ACK PUCCH resource described above, the SR PUCCH resource may not be included in the set of PUCCH resource. Otherwise, the SR PUCCH resource may be included in the set of PUCCH resources.

The following UCI multiplexing procedure may be performed over the set of PUCCH resources.

Firstly, a first PUCCH resource with the earliest starting symbol and the longest duration in the slot is determined (e.g., selected) from the set of PUCCH resources. Accordingly, a first group of overlapping PUCCH resources (including the first PUCCH resource and PUCCH resource(s) overlapping the first PUCCH resource (if any)) is determined from the set of PUCCH resources.

Secondly, a second PUCCH resource (may be the same as or different from the first PUCCH resource) is determined (e.g., selected) from the first group of overlapping PUCCH resources for carrying multiplexed UCIs of the first group of overlapping PUCCH resources. For example, the second PUCCH resource may be determined (e.g., selected) from the first group of overlapping PUCCH resources based on some rules for multiplexing UCI of overlapping PUCCH resources which depends on the types of the UCI and PUCCH formats of the overlapping PUCCH resources. The second PUCCH resource may be determined (e.g., selected) from the first group of overlapping PUCCH resources based on the PRI and the payload size of the UCI of first group of overlapping PUCCH resources when a HARQ-ACK PUCCH resource scheduled by DCI is in the first group of overlapping PUCCH resources and when the payload size cannot be accommodated by the PUCCH resource set including the HARQ-ACK PUCCH resource.

Thirdly, PUCCH resource(s) with UCI(s) multiplexed in the second PUCCH resource (e.g., the PUCCH resource(s) in the first group of overlapping PUCCH resources except for the second PUCCH resource) is excluded from the set of PUCCH resources. In a case that the second PUCCH resource is not included in the set of PUCCH resources (e.g., in a case that the second PUCCH resource is determined based on the PRI from a second PUCCH resource set when the payload size of the UCI of the first group of overlapping PUCCH resources cannot be accommodated by a first PUCCH resource set that includes the HARQ-ACK PUCCH resource in the first group of overlapping PUCCH resources), the second PUCCH resource is included in the set of PUCCH resources. Accordingly, a second group of overlapping PUCCH resources (including the second PUCCH resource and PUCCH resource(s) overlapping the second PUCCH resource (if any)) is determined from the remaining PUCCH resources of the set of PUCCH resources.

Fourthly, a third PUCCH resource (may be the same as or different from the second PUCCH resource) is determined (e.g., selected) from the second group of overlapping PUCCH resources for carrying multiplexed UCIs of the second group of overlapping PUCCH resources. For example, the third PUCCH resource may be determined (e.g., selected) from the second group of overlapping PUCCH resources based on some rules for multiplexing UCI of overlapping PUCCH resources which depends on the types of the UCI and PUCCH formats of the overlapping PUCCH resources. The third PUCCH resource may be determined (or selected) from the second group of overlapping PUCCH resources based on the PRI and the payload size of the UCI of second group of overlapping PUCCH resources when a HARQ-ACK PUCCH resource scheduled by DCI is in the second group of overlapping PUCCH resources and when the payload size cannot be accommodated by the PUCCH resource set including the HARQ-ACK PUCCH resource.

The multiplexing procedure may be performed iteratively until (at most) two non-overlapping PUCCHs are determined.

It should be noted that when a PUCCH resource (e.g., the second PUCCH resource or the third PUCCH resource) is selected from a group of overlapping PUCCH resources including a PUCCH resource for HARQ-ACK scheduled by DCI, the PUCCH resource may be determined based on PRI in the scheduling DCI. The PRI may indicate an index corresponding to the order of the determined PUCCH resource in a PUCCH resource set. The PUCCH resource set may be determined by the payload size of HARQ-ACK and other UCI in the group of overlapping PUCCH resources.

The PUCCH resource set may be determined as follows.

If the UE transmits O_{UCI} UCI information bits, that include HARQ-ACK information bits, the UE may determine (or select) the PUCCH resource set to be one of the following, wherein O_{UCI}, may be the total payload size of multiplexed UCI(s).
a first set of PUCCH resources with pucch-ResourceSetId=0, if O_{UCI}≤2 and the UCI information bits include 1 or 2 HARQ-ACK information bits, and a positive (or negative SR) on one SR transmission occasion if transmission of HARQ-ACK information and transmission of SR occur simultaneously.
a second set of PUCCH resources with pucch-ResourceSetId=1, if pucch-ResourceSetId=1 is provided by higher layers, and if 2<O_{UCI}≤N₂. N₂ may be equal to maxPayloadSize if maxPayloadSize is provided for the PUCCH resource set with pucch-ResourceSetId=1; otherwise N₂ may be equal to 1706.
a third set of PUCCH resources with pucch-ResourceSetId=2, if pucch-ResourceSetId=2 is provided by higher layers, and if N₂<O_{UCI}≤N₃. N₃ may be equal to maxPayloadSize if maxPayloadSize is provided for the PUCCH resource set with pucch-ResourceSetId=2; otherwise N₃ may be equal to 1706.
a fourth set of PUCCH resources with pucch-ResourceSetId=3, if pucch-ResourceSetId=3 is provided by higher layers, and if N₃<O_{UCI}≤1706.

After the multiplexed UCIs and the PUCCH carrying the multiplexed UCIs are determined, the UE may multiplex the multiplexed UCIs in a PUSCH if the PUCCH carrying the multiplexed UCIs overlaps the PUSCH in time domain.

More than one PUCCH resource set for unicast PUCCH may be configured in a PUCCH-Config for PDSCH. A unicast PUCCH for HARQ-ACK corresponding to a PDSCH may be selected, based on PRI in a PDCCH scheduling the PDSCH, from one of the PUCCH resource sets. The one of the PUCCH resource sets may be determined based on a payload size of a HARQ-ACK codebook including the HARQ-ACK.

More than one PUCCH resource set for multicast PUCCH may be configured in a PUCCH-Config for group common PDSCH. A multicast PUCCH for HARQ-ACK corresponding to a group common PDSCH may be selected, based on PRI in a group common PDCCH scheduling the group common PDSCH, from one of the PUCCH resource sets. The one of the PUCCH resource sets may be determined based on a payload size of a HARQ-ACK codebook including the HARQ-ACK.

If a PUCCH resource is used (only) for HARQ-ACK transmission with O_{ACK} HARQ-ACK information bits and O_{CRC} bits using PUCCH format 2 or PUCCH format 3 in a PUCCH resource that includes a number of PRBs M_{RB}^{PUCCH} (e.g., provided respectively by nrofPRBs of PUCCH-format2 or nrofPRBs of PUCCH-format3), the UE may determine a number of PRBs M_{RB,min}^{PUCCH} for the PUCCH transmission to be the minimum number of PRBs that results to (O_{ACK}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{ACK}+O_{CRC})>(M_{RB,min}^{PUCCH}−1)·N_{sc,ctrl}^{RB}·N_{symb-UCI}^{PUCCH}·Qₘ·r. M_{RB,min}^{PUCCH}≤M_{RB}^{PUCCH}. The M_{RB,min}^{PUCCH} PRBs may start from the first PRB from the M_{RB}^{PUCCH} of PRBs.

For PUCCH format 3, if M_{RB,min}^{PUCCH} is not equal 2^{α}^{₂}·3^{α}^{₃}·5^{α}^{₅} (e.g., according to TS 38.211), M_{RB}^{PUCCH} may be increased to the nearest allowed value of nrofPRBs for PUCCH-format3. If (O_{ACK}+O_{CRC})>(M_{RB}^{PUCCH}−1)·N_{sc,ctrl}^{RB}·N_{symb-UCI}^{PUCCH}·Qₘ·r, the UE may transmit the PUCCH over M_{RB}^{PUCCH} PRBs.

When it is determined to use a PUCCH resource configured by multi-CSI-PUCCH-ResourceList to multiplex all the CSI reports of the CSI PUCCH resources and HARQ-ACK/SR information in the slot, wherein the HARQ-ACK (if any) is in response to a PDSCH reception without a corresponding PDCCH, the PUCCH resource and the number of PRBs for the PUCCH resource may be determined as follows.
The UE is provided by multi-CSI-PUCCH-ResourceList with J≤2 PUCCH resources in the slot, for PUCCH format 2 and/or PUCCH format 3 and/or PUCCH format 4, where the resources are indexed according to an ascending order for the product of a number of corresponding REs, a modulation order Qₘ, and a configured code rate r;
if (O_{ACK}+O_{SR}+O_{CSI}+O_{CRC})≤(M_{RB}^{PUCCH}·N_{sc,ctrl}^{RB}·N_{symb-UCI}^{PUCCH}·Qₘ·r)₀, the UE may use PUCCH format 2 resource 0, the PUCCH format 3 resource 0, or the PUCCH format 4 resource 0;
else if (O_{ACK}+O_{SR}+O_{CSI}+O_{CRC})>(M_{RB}^{PUCCH}·N_{sc,ctrl}^{RB}·N_{symb-UCI}^{PUCCH}·Qₘ·r)ⱼ and (O_{ACK}+O_{SR}+O_{CSI}+O_{CRC})≤(M_{RB}^{PUCCH}·N_{RB}^{sc,ctrl}·N_{symb-UCI}^{PUCCH}·Qₘ·r)ⱼ₊₁, 0≤j<J −1, the UE may transmit a PUCCH conveying HARQ-ACK information, SR and CSI report(s) in a respective PUCCH where the UE uses the PUCCH format 2 resource j+1, the PUCCH format 3 resource j+1, or the PUCCH format 4 resource j+1;
else the UE may use the PUCCH format 2 resource j −1, or the PUCCH format 3 resource J −1, or the PUCCH format 4 resource j −1 and the UE may selects N_{CSI}^{reported} CSI report(s) for transmission together with HARQ-ACK information and SR, when any, in ascending priority value (e.g., as described in TS 38.214).

If the UE is provided SPS-PUCCH-AN-List-r16 and transmits O_{UCI} UCI information bits that include (only) HARQ-ACK information bits in response to one or more SPS PDSCH receptions, the UE may determine a PUCCH resource to be one of the following:
a PUCCH resource provided by sps-PUCCH-AN-ResourceID obtained from the first entry in sps-PUCCH-AN-List-r16, if O_{UCI}≤2, or
a PUCCH resource provided by sps-PUCCH-AN-ResourceID obtained from the second entry in sps-PUCCH-AN-List-r16, if provided, if 2<O_{UCI}≤N_{1,SPS} where N_{1,SPS} is either provided by maxPayloadSize obtained from the second entry in sps-PUCCH-AN-List-r16 or is otherwise equal to 1706, or
a PUCCH resource provided by sps-PUCCH-AN-ResourceID obtained from the third entry in sps-PUCCH-AN-List-r16, if provided, if N_{1,SPS}<O_{UCI}≤N_{2,SPS} where N_{2,SPS} is either provided by maxPayloadSize obtained from the third entry in sps-PUCCH-AN-List-r16 or is otherwise equal to 1706, or
a PUCCH resource provided by sps-PUCCH-AN-ResourceID obtained from the fourth entry in sps-PUCCH-AN-List-r16, if provided, if N_{2,SPS}<O_{UCI}≤N_{3,SPS} where N_{3,SPS} is equal to 1706.

In the 3GPP Rel-16, the UE may be configured with 2 HARQ-ACK codebooks.

If the UE is provided with pdsch-HARQ-ACK-Codebook-List, the UE may be indicated by pdsch-HARQ-ACK-Codebook-List to generate one or two HARQ-ACK codebooks. If the UE is indicated to generate one HARQ-ACK codebook, the HARQ-ACK codebook may be associated with a PUCCH of priority index 0. If the UE is provided with pdsch-HARQ-ACK-Codebook-List, the UE may multiplex, in a same HARQ-ACK codebook, (only) HARQ-ACK information associated with a same (physical layer) priority index.

If the UE is indicated to generate two HARQ-ACK codebooks, a first HARQ-ACK codebook may be associated with a PUCCH of priority index 0 (e.g., low priority) and a second HARQ-ACK codebook may be associated with a PUCCH of priority index 1 (e.g., high priority).

The UE may be provided with the first and second HARQ-ACK codebooks for each of {PUCCH-Config, UCI-OnPUSCH, PDSCH-codeBlockGroupTransmission} by {PUCCHConfigurationList, UCI-OnPUSCH-List, PDSCH-CodeBlockGroupTransmission-List}, respectively.

In some cases, the UE may not report a Type-1 HARQ-ACK codebook.

If the UE reports HARQ-ACK information in a specific PUCCH within the M_{A,c} occasion(s) for candidate PDSCH receptions (e.g., as described in TS 38.213), the UE may determine a HARQ-ACK codebook (only) for the SPS PDSCH release, (only) for the PDSCH reception, or (only) for one SPS PDSCH reception according to corresponding M_{A,c} occasion(s) on respective serving cell(s). The value of counter DAI in DCI format 1_0 may be described in TS 38.213 (e.g., according to Table 9.1.3-1). HARQ-ACK information bits may be in response to more than one SPS PDSCH reception that the UE is configured to receive. Otherwise, the procedures for a Type-1 HARQ-ACK codebook or a Type-2 HARQ-ACK codebook determination may be applied (e.g., as described in TS 38.213).

The specific PUCCH may be for one of the following:
a SPS PDSCH release indicated by DCI format 1_0 with counter DAI field value of 1, or
a PDSCH reception scheduled by DCI format 1_0 with counter DAI field value of 1 on the PCell, or
SPS PDSCH reception(s).

Issues regarding handling multiplexing of multicast PUCCH(s) may be as follows.

### PUCCH Scheduling

For an ACK/NACK based HARQ-ACK feedback, different PUCCH resources for different UEs may be scheduled by the same group common PDCCH. That is, a PRI field and a PDSCH-to-HARQ_feedback timing indicator field (e.g., K1 field) (in the group common PDCCH) may (need to) indicate the different PUCCH resources for the different UEs.

### Multiplexing of Unicast PUCCH(s) and Multicast PUCCH(s)

When the UE has a HARQ-ACK for group common PDSCH and a HARQ-ACK for dedicated PDSCH to be transmitted in the same slot, the HARQ-ACK for group common PDSCH and the HARQ-ACK for dedicated PDSCH may (need to) be multiplexed in a PUCCH if a multicast PUCCH and a unicast PUCCH are overlapping in time.

### Type-1 HARQ-ACK Codebook

When determining (e.g., constructing) a Type-1 HARQ-ACK codebook for a PUCCH (e.g., under the scenario that PDSCH repetition is not enabled), one or more sets of slots may be determined based on a specific slot in which the PUCCH is (to be) transmitted and one or more HARQ-ACK feedback offsets configured by a PUCCH configuration. Accordingly, a number of HARQ-ACK bit may be determined for a slot of each the one or more sets of slots. The at least one HARQ-ACK bit for the slot may be determined based on a TDRA table and a TDD configuration. A PDSCH candidate position may be defined by an SLIV in the TDRA table. Based on SLIVs and available symbols (e.g., DL or flexible symbols) in the slot, a set of SLIVs may be determined which results in the maximum number of non-overlapping valid PDSCH candidate positions in the slot. The PDSCH candidate positions may be valid if the symbols defined by the corresponding SLIV in the slot does not conflict with UL symbol(s). The at least one HARQ-ACK bit in the slot may be determined as the maximum number of non-overlapping valid PDSCH candidate positions in the slot. Each of the at least one HARQ-ACK bit for the slot may correspond to a valid PDSCH candidate position of the valid PDSCH candidate positions defined by the set of SLIVs, or may correspond to other valid PDSCH candidate positions overlapping the valid PDSCH candidate position.

When the UE is (only) capable of receiving one PDSCH in a slot, there may be at most one HARQ-ACK bit for the slot. That is, there may be one HARQ-ACK bit for the slot when there is at least one valid PDSCH candidate position in the slot. Otherwise, there may be no HARQ-ACK bit for the slot. It should be noted that at most one TB in a PDSCH may be applied to the above. If there is at most two TBs in the PDSCH, there may be two HARQ-ACK bits corresponding to a valid PDSCH candidate position.

When a HARQ-ACK for multicast PUCCH and a HARQ-ACK for unicast PUCCH are multiplexed, and when the types of a HARQ-ACK codebook for the HARQ-ACK for multicast PUCCH and a HARQ-ACK codebook for the HARQ-ACK for unicast PUCCH are both Type-1 HARQ-ACK codebooks, parameters for both of a multicast configuration and a dedicated configuration may (need to) be considered for the determination (e.g., construction) of the Type-1 HARQ-ACK codebook. Combination (e.g., union) of a TDRA table in a dedicated PDSCH-Config and a TDRA table in a PDSCH-Config for multicast may be used to determine PDSCH candidate positions for the determination of the Type-1 HARQ-ACK codebook.

### DAI in UL Grant

Two bits of a DAI (field) (e.g., UL-DAI) in a UL grant may be used to indicate total DAI(s) of a Type-2 HARQ-ACK codebook when the Type-2 HARQ-ACK codebook is multiplexed in a PUSCH scheduled by the UL grant. Since the total DAI(s) is used to derive the size of the Type-2 HARQ-ACK codebook, the UL-DAI may be used to ensure the Type-2 HARQ-ACK are with the correct size when multiplexed in the PUSCH.

One bit of a DAI (field) (e.g., UL-DAI) in a UL grant may be used to indicate whether a Type-1 HARQ-ACK codebook is multiplexed in a PUSCH scheduled by the UL grant. When a HARQ-ACK for multicast PUCCH and a HARQ-ACK for unicast PUCCH are multiplexed in the PUSCH, and when the types of the HARQ-ACK codebooks for the HARQ-ACK for multicast PUCCH and the HARQ-ACK for unicast PUCCH are both Type-2 HARQ-ACK codebooks, the DAI may (need to) be extended for indication of total DAI(s) for the Type-2 HARQ-ACK codebook for multicast.

Implementations for handling the above issues may be as follows.

### PUCCH Scheduling

Implementations for scheduling a multicast PUCCH may be as follows.

In some implementations, a PUCCH-Config for multicast may be provided to a UE. For example, the PUCCH-Config may be configured together with a CFR as part of the CFR configuration. A dl-DataToUL-ACK IE may be included in the PUCCH-Config for configuration of a K1 set for scheduling a multicast PUCCH. A resourceSetToAddModList IE and a resourceToAddModList IE may be included for configuration of up to 4 PUCCH resource sets from which the multicast PUCCH may be scheduled. The UE may determine the multicast PUCCH for HARQ-ACK for a group common PDSCH based on the above configurations, PRI field and K1 field in a group common PDCCH scheduling the group common PDSCH. The PRI may indicate the order of the scheduled PUCCH resource in the PUCCH resource set determined by the payload size of the HARQ-ACK for the group common PDSCH. K1 may indicate a slot offset counted from a first UL slot overlapping a DL slot in which the group common PDSCH is received to a second UL slot in which the PUCCH resource is scheduled. When the SCS of UL slots are larger than the SCS of DL slots, the slot offset may be counted from a UL slot which is the latest UL slot (of the UL slots) that overlaps the DL slot in which the group common PDSCH is received. When determining the slot in which the multicast PUCCH is scheduled, the issue of PUCCH overriding and out-of-order PDSCH-to-PUCCH may be considered.

In some implementations, when there is a unicast PUCCH scheduled in a slot n, and when a group common PDSCH is scheduled by a group common PDCCH that ends in a symbol that is within N3 symbols before a starting symbol of the unicast PUCCH, a slot in which the multicast PUCCH is scheduled may be reselected if the slot n is determined based on a K1 field in the group common PDCCH. When the unicast PUCCH and the multicast PUCCH are scheduled in the same slot, the unicast PUCCH and the multicast PUCCH may be multiplexed. In some implementations, a first K1 value in dl-DataToUL-ACK that is next to a second K1 value indicated by the K1 field in the group common PDCCH may be selected. In some implementations, the first K1 value in dl-DataToUL-ACK that is the x-th K1 value after the second K1 value indicated by the K1 field in the group common PDCCH may be selected, and x may be configurable. In some implementations, a HARQ-ACK bit for the group common PDSCH may not be transmitted (in this case). In some implementations, the K1 value may be determined as an inapplicable value, and the HARQ-ACK bit for the group common PDSCH may be transmitted in a next valid PUCCH for HARQ-ACK.

In some other implementations, when the UE is scheduled with a unicast PDSCH with its corresponding HARQ-ACK assigned to be transmitted via a unicast PUCCH in a slot n, and when a group common PDSCH (e.g., which starts later than the unicast PDSCH) with its corresponding HARQ-ACK assigned to be transmitted via a multicast PUCCH in a slot m (e.g., which ends before a start of the unicast PUCCH), a slot in which the multicast PUCCH is scheduled may be reselected. In some implementations, the first K1 value in dl-DataToUL-ACK that results in the multicast PUCCH to be transmitted in the slot n or in a slot after the slot n may be selected. In some implementations, the first K1 value in dl-DataToUL-ACK that is the x-th K1 value after the second K1 value indicated by the K1 field in the group common PDCCH may be selected, and x may be configurable. In some implementations, K1 value may not (need to) be reselected if the UE reports a capability The capability may be an out-of-order PDSCH-to-PUCCH capability or a FDM multicast/unicast PDSCH capability. In some implementations, the HARQ-ACK for the group common PDSCH may be multiplexed in the unicast PUCCH in the slot n (in this case). In some implementations, the HARQ-ACK for the group common PDSCH may not be transmitted (in this case). In some implementations, the K1 value may be determined as an inapplicable value. The HARQ-ACK bit for the group common PDSCH may be transmitted in a next valid PUCCH for HARQ-ACK.

Implementations for determining a PUCCH resource set for a HARQ-ACK for group common PDSCH may be as follows.

In some implementations, if the UE transmits O_{ACK} HARQ-ACK information bits, the UE may determine a PUCCH resource set to be
a first set of PUCCH resources with pucch-ResourceSetId=0 if O_{ACK}≤2 including 1 or 2 HARQ-ACK information bits, or
a second set of PUCCH resources with pucch-ResourceSetId=1, if provided by higher layers, if 2<O_{ACK}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{ACK}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

Implementations for reporting (only) a HARQ-ACK information bit for a group common PDSCH in a multicast PUCCH may be as follows.

In some implementations, for a serving cell c, if a UE reports HARQ-ACK information in a PUCCH (only) for a SPS group common PDSCH release, (only) for a group common PDSCH, or (only) for a group common SPS PDSCH within M_{A,c} occasions for candidate PDSCH receptions determined for a Type-1 HARQ-ACK codebook for transmission in a PUCCH configured in PUCCH-Config for multicast, the UE may determine (only) one HARQ-ACK information bit to be present for the serving cell c in the Type-1 HARQ-ACK codebook. A PDCCH corresponding to the SPS group common PDSCH release or the group common PDSCH may be with a counter DAI field value of 1. A DCI format of the PDCCH may be a DCI format 1_0, a DCI format 1_1, or a DCI format 1_2. For the DCI format 1_1 or the DCI format 1_2, an RRC configuration to configure a counter DAI field may be considered. The (explicit) RRC configuration for enabling the DAI field may be as follows.

In some implementations, the UE may be (configured) with an (explicit) RRC configuration, wherein the RRC configuration may be an IE in the PUCCH-Config for multicast.

In some implementations, the UE may determine that (only) one HARQ-ACK information bit is present for the serving cell c in the Type-1 HARQ-ACK codebook if the PDCCH corresponding to the SPS group common PDSCH release or group common PDSCH is with the counter DAI field of a specific value, wherein the value may be RRC configured (e.g., by the (explicit) RRC configuration).

In some implementations, a group common PDSCH may be scheduled by a DCI format 1_0. An indicated K1 value may not (be restricted to) belong to the intersection of a set of slot timing values {1, 2, 3, 4, 5, 6, 7, 8} and other K1 values provided by dl-DataToUL-ACK or dl-DataToUL-ACK-DCI-1-2 for other DCI formats configured for an active DL BWP of a corresponding serving cell. If the DCI format 1_0 is used for scheduling the group common PDSCH for a serving cell, when determining (e.g., constructing) a Type-1 HARQ-ACK codebook to be transmitted in a PUCCH (e.g., configured by PUCCH-Config for unicast), the K1 values for the serving cell may be provided by the union of {1, 2, 3, 4, 5, 6, 7, 8}, dl-DataToUL-ACK and dl-DataToUL-ACK-ForDCIFormat1_2 associated with the DCI formats configured for the active DL BWP of the serving cell.

In some implementations, if a unicast PDSCH can be scheduled by a DCI format 1_0 and a DCI format 1_1 (or a DCI format 1_2), when K1 values for determining (e.g., constructing) a Type-1 HARQ-ACK codebook is determined by the union of K1 set for multicast DCI format and K1 set for UE-specific DCI formats, K1 values that can be indicated for scheduling unicast PDSCH by the DCI format 1_0 may be the intersection of a set of slot timing values {1, 2, 3, 4, 5, 6, 7, 8} and the union of the K1 set of UE-specific DCI formats and the K1 set of multicast DCI formats.

In some implementations, if the UE is provided dl-DataToUL-ACK specific for a MBS group common PDSCH or for a MBS specific DCI format, the UE may not expect to be indicated (e.g., by a DCI format 10) a slot timing value for transmission of HARQ-ACK information that does not belong to the intersection of a set of slot timing values {1, 2, 3, 4, 5, 6, 7, 8} and a set of slot timing values provided by dl-DataToUL-ACK specific for the MBS group common PDSCH or for the MBS specific DCI format.

### Multiplexing of Unicast PUCCH and Multicast PUCCH

Implementations for multiplexing multicast PUCCH(s) and unicast PUCCH(s) may be as follows.

In some implementations, when the UE reports a UE capability of transmitting more than one PUCCH for HARQ-ACK in a slot, multicast PUCCH(s) in a slot n may be multiplexed with unicast PUCCH(s) in the slot n if the unicast PUCCH(s) is a PUCCH for HARQ-ACK for unicast PDSCH with a corresponding PDCCH or a PUCCH configured by multi-CSI-PUCCH-ResourceList for transmitting more than one overlapping CSI PUCCH, and if the multicast PUCCH overlaps the unicast PUCCH. The interaction of a multicast PUCCH and a UCI multiplexing procedure may be described as follows.

In some implementations, after determining a set of PUCCH resources (e.g., PUCCH resource set Q) for performing a UCI multiplexing procedure in a slot, whether a multicast PUCCH is overlapping a unicast PUCCH in the set of PUCCH resources may be determined before the UCI multiplexing procedure is performed for one or more overlapping unicast PUCCHs in the slot. In other words, a unicast PUCCH determined based on the payload size of HARQ-ACK for unicast PDSCH, PRI and K1 indicated in a corresponding PDCCH or a unicast PUCCH configured by multi-CSI-PUCCH-ResourceList may be used to determine whether there is overlapping multicast PUCCH(s). When it is determined that a multicast PUCCH is overlapping with a unicast PUCCH, the HARQ-ACK payload (size) of group common PDSCH is (virtually) multiplexed in the unicast PUCCH. Then, the UCI multiplexing procedure may be performed on the set of PUCCH resources including the unicast PUCCH (referred as unicast PUCCH G) that (virtually) multiplexes the HARQ-ACK for group common PDSCH. When there is PUCCH resource(s) overlapping the unicast PUCCH G, a unicast PUCCH determined from a group of overlapping PUCCH resources including the unicast PUCCH G may be based on the existing rule/mechanism. In other words, the unicast PUCCH G may be determined to be associated with a type of UCI without considering the (virtually) multiplexed HARQ-ACK for group common PDSCH, but when determining the unicast PUCCH for multiplexing the UCI of the group of overlapping PUCCH resources, the payload size of the HARQ-ACK for group common PDSCH may be considered.

In some implementations, when it is determined that a multicast PUCCH is overlapping a unicast PUCCH for HARQ-ACK with a corresponding PDCCH or a unicast PUCCH configured by multi-CSI-PUCCH-ResourceList, the HARQ-ACK payload (size) of group common PDSCH may be firstly multiplexed in the unicast PUCCH, and the resulting unicast PUCCH may be included in the set of PUCCH resources (e.g., PUCCH resource set Q). Then, the UCI multiplexing procedure may be performed over the set of PUCCH resources. When the unicast PUCCH is for HARQ-ACK with a corresponding PDCCH and when the unicast PUCCH cannot accommodate the HARQ-ACK for group common PDSCH, another PUCCH resource set in PUCCH-Config for unicast may be selected based on the payload size of the HARQ-ACK for unicast PDSCH and the HARQ-ACK for group common PDSCH, and another PUCCH resource may be selected from the selected PUCCH resource set based on PRI in the PDCCH scheduling the unicast PDSCH. When the unicast PUCCH is configured by multi-CSI-PUCCH-ResourceList and when the unicast PUCCH cannot accommodate the HARQ-ACK for group common PDSCH, another PUCCH resource configured by multi-CSI-PUCCH-ResourceList may be selected based on the payload size of the multiplexed CSI reports and the HARQ-ACK for group common PDSCH.

In some implementations, if a multicast PUCCH is not overlapping a unicast PUCCH for HARQ-ACK with a corresponding PDCCH or a unicast PUCCH configured by multi-CSI-PUCCH-ResourceList, and if other PUCCH resources (e.g., HARQ-ACK PUCCH resource without a corresponding PDSCH, CSI PUCCH resource not configured by multi-CSI-PUCCH-ResourceList, or SR PUCCH resource) are overlapping the multicast PUCCH, UCI of the overlapping PUCCH resources may be multiplexed in the multicast PUCCH if the number of PRBs determined for the multicast PUCCH is the same with or without the UCI of other PUCCH resources or if the number of PRBs determined for the multicast PUCCH with the UCI of the overlapping PUCCH resources does not exceed the maximum number of PRBs configured for the multicast PUCCH. In some implementations, the overlapping PUCCH resources may be excluded from the set of PUCCH resources (e.g., PUCCH resource set Q) in this case. In some implementations, the multicast PUCCH resources may be dropped in this case.

In some implementations, a multicast PUCCH may be included in a set of PUCCH resources (e.g., PUCCH resource set Q) over which the UCI multiplexing procedure is performed. During the UCI multiplexing procedure, if the multicast PUCCH is included in a group of overlapping PUCCH resources that includes a PUCCH resource for HARQ-ACK for unicast PDSCH with a corresponding PDCCH or a PUCCH resource configured by multi-CSI-PUCCH-ResourceList for transmitting more than one overlapping CSI PUCCH, the PUCCH resource may be determined based on existing rules/mechanisms to multiplex UCI of the group of overlapping PUCCH resources including the HARQ-ACK for group common PDSCH. In other words, when there is a HARQ-ACK PUCCH resource with the corresponding PDCCH in the group of overlapping PUCCH resources, the PUCCH resource determined to multiplex the UCI of the group of overlapping PUCCH resources including HARQ-ACK for group common PDSCH may be based on the total payload size of the UCI and PRI. When there is a PUCCH resource configured by multi-CSI-PUCCH-ResourceList and there is no HARQ-ACK PUCCH resource with the corresponding PDCCH in the group of overlapping PUCCH resources, the PUCCH resource configured by multi-CSI-PUCCH-ResourceList may be determined to multiplex the UCI of the group of overlapping PUCCH resources including HARQ-ACK for group common PDSCH.

In some implementations, if the multicast PUCCH is included in a group of overlapping PUCCH resources that does not include a PUCCH resource for HARQ-ACK for unicast PDSCH with a corresponding PDCCH or a PUCCH resource configured by multi-CSI-PUCCH-ResourceList for transmitting more than one overlapping CSI PUCCH, the multicast PUCCH may be dropped. In some implementations, the multicast PUCCH may be determined as the resulting PUCCH (selected) from the group of overlapping PUCCH resources, and other/remaining PUCCH resource(s) in the group of overlapping PUCCH resources may be dropped. In some implementations, the multicast PUCCH may be determined as the resulting PUCCH (selected) from the group of overlapping PUCCH resources, and other/remaining PUCCH resource(s) in the group of overlapping PUCCH resources may be multiplexed in the multicast PUCCH if the number of PRBs determined for the multicast PUCCH is the same with or without the UCI of other PUCCH resources or if the number of PRBs determined for the multicast PUCCH with the UCI of other PUCCH resources does not exceed the maximum number of PRBs configured for the multicast PUCCH. In some implementations, the multicast PUCCH may be determined as the resulting PUCCH (selected) from the group of overlapping PUCCH resources, and UCI of other PUCCH resources in the group of overlapping PUCCH resources may be multiplexed in the multicast PUCCH, or another multicast PUCCH may be determined as the resulting PUCCH (selected) from the group of overlapping PUCCH resources, and UCI of other PUCCH resources in the group of overlapping PUCCH resources may be multiplexed in the other multicast PUCCH selected from a PUCCH resource set based on the PRI in a group common PDCCH scheduling the group common PDSCH corresponding to HARQ-ACK in the multicast PUCCH. The PUCCH resource set may be determined based on the payload size of the HARQ-ACK and UCI of other PUCCH resources and may be different from the PUCCH resource set (e.g., determined based on (only) the HARQ-ACK corresponding to the group common PDSCH) including the multicast PUCCH.

In some implementations, whether a multicast PUCCH is overlapping a unicast PUCCH for HARQ-ACK with a corresponding PDCCH or with a unicast PUCCH configured by multi-CSI-PUCCH-ResourceList may be determined after the UCI multiplexing procedure is performed for one or more overlapping unicast PUCCHs in a slot. When it is determined that the multicast PUCCH is overlapping the unicast PUCCH, the HARQ-ACK for group common PDSCH may be multiplexed in the unicast PUCCH. In some implementations, when the unicast PUCCH is for HARQ-ACK with the corresponding PDCCH and when the unicast PUCCH cannot accommodate the HARQ-ACK for group common PDSCH, another PUCCH resource set in PUCCH-Config for unicast may be selected based on the payload size of the UCI multiplexed in the unicast PUCCH and the HARQ-ACK for group common PDSCH. Another PUCCH resource may be selected from the selected PUCCH resource set based on PRI in the PDCCH scheduling the unicast PDSCH. In some implementations, when the unicast PUCCH cannot accommodate the HARQ-ACK for group common PDSCH, the multicast PUCCH may be dropped.

In some implementations, after the UCI multiplexing procedure is performed for a unicast PUCCH in a slot, when a PUCCH configured by multi-CSI-PUCCH-ResourceList is determined to be used for transmitting more than one CSI reports, if a multicast PUCCH is overlapping the PUCCH, a HARQ-ACK for group common PDSCH may be multiplexed in the PUCCH. The number of PRBs for the PUCCH transmission may be determined based on the payload size of the one or more CSI reports and the HARQ-ACK for group common PDSCH, and the maximum code rate of the PUCCH format.

In some implementations, after the UCI multiplexing procedure is performed for a unicast PUCCH in a slot, if a multicast PUCCH is not overlapping a unicast PUCCH for HARQ-ACK with a corresponding PDCCH or a unicast PUCCH configured by multi-CSI-PUCCH-ResourceList, and if other PUCCH resources (e.g., HARQ-ACK PUCCH resource without a corresponding PDSCH, CSI PUCCH resource not configured by multi-CSI-PUCCH-ResourceList, or SR PUCCH resource) are overlapping the multicast PUCCH, UCI of the overlapping PUCCH resources may be multiplexed in the multicast PUCCH if the number of PRBs determined for the multicast PUCCH is the same with or without the UCI of other PUCCH resources or if the number of PRBs determined for the multicast PUCCH with the UCI of the overlapping PUCCH resources does not exceed the maximum number of PRBs configured for the multicast PUCCH. In some implementations, the overlapping PUCCH resources may be dropped in this case.

It should be noted that one or more of the above implementations may be combined. For example, some implementations may be used if a multicast PUCCH is not overlapping a unicast PUCCH for HARQ-ACK with a corresponding PDCCH or a unicast PUCCH configured by multi-CSI-PUCCH-ResourceList but is overlapping other PUCCH resources. Some implementations may be used to resolve the other overlapping PUCCH resource. For example, during (or after) the UCI multiplexing procedure, the multicast PUCCH may be overlapping the unicast PUCCH for HARQ-ACK with the corresponding PDCCH or the unicast PUCCH configured by multi-CSI-PUCCH-ResourceList and the multicast PUCCH may be multiplexed with the unicast PUCCH.

In some implementations, the UE capability may be a new UE capability or may be the UE capability defined by at least one of twoPUCCH-Type5-r16, twoPUCCH-Type6-r16, twoPUCCH-Type7-r16, twoPUCCH-Type8-r16, twoPUCCH-Type9-r16, or twoPUCCH-Type10-r16. Depending on the reported UE capability, the above implementations may be applicable for specific combinations of sub-slot configurations. For example, the above implementations may be applicable if the UE capability (e.g., twoPUCCH-Type5-r16, twoPUCCH-Type7-r16, or twoPUCCH-Type9-r16) supports a sub-slot based HARQ-ACK codebook and a slot based HARQ-ACK codebook in a sub-slot and if PUCCH-Config for unicast is configured with subslotLengthForPUCCH-r16 and PUCCH-Config for multicast is not configured with subslotLengthForPUCCH-r16. For another example, the above implementations may be applicable if the UE capability (e.g., twoPUCCH-Type6-r16, twoPUCCH-Type8-r16, or twoPUCCH-Type10-r16) supports two sub-slot based HARQ-ACK codebooks in a sub-slot and if PUCCH-Config for unicast is configured with subslotLengthForPUCCH-r16 and PUCCH-Config for multicast is configured with subslotLengthForPUCCH-r16. Otherwise, the below implementations may be applicable.

In some implementations, (only) HARQ-ACK for group common PDSCH with corresponding a PDCCH that ends before (or ends not after) the end of the last DCI scheduling a unicast PDSCH with corresponding HARQ-ACK to be transmitted in a unicast PUCCH in a slot may be considered for multiplexing the unicast PUCCH and a multicast PUCCH in the slot.

In some implementations, (only) HARQ-ACK for group common PDSCH with corresponding PDCCH that ends not within T_{proc,2}^{mux} before the earliest of the start of the overlapping unicast PUCCH and the multicast PUCCH in a slot may be considered for multiplexing the unicast PUCCH and the multicast PUCCH in the slot.

It should be noted that the multicast PUCCH in the slot n in the above implementations may be determined (e.g., based on the payload size of the HARQ-ACK for group common PDSCH without a corresponding PDCCH) from the PUCCH resources configured by SPS-PUCCH-AN-List-r16 configured in PUCCH-Config for multicast or the multicast PUCCH may be configured by n1PUCCH-AN in a SPS-Config for multicast. The multicast PUCCH may be determined based on the payload size of the HARQ-ACK for group common PDSCH with the corresponding PDCCH and the HARQ-ACK for group common PDSCH without the corresponding PDCCH and based on PRI in the PDCCH scheduling the group common PDSCH when the multicast PUCCH determined based on the payload size of the HARQ-ACK for group common PDSCH with the corresponding PDCCH and the PRI in the PDCCH scheduling the group common PDSCH overlaps a PUCCH for HARQ-ACK for group common PDSCH without the corresponding PDCCH. In other words, the multicast PUCCH for HARQ-ACK for group common PDSCH without the corresponding PDCCH and the multicast PUCCH for HARQ-ACK for group common PDSCH with the corresponding PDCCH may be multiplexed first if they overlap each other before the above implementations are performed.

In some implementations, when the UE does not report a UE capability of transmitting more than one PUCCH for HARQ-ACK in a slot, a multicast PUCCH in a slot n may be multiplexed with a unicast PUCCH in the slot n if both the unicast PUCCH for HARQ-ACK and multicast PUCCH are scheduled in the slot n. For determination of a PUCCH resource for the HARQ-ACK for unicast PDSCH and group common PDSCH to be included in the PUCCH resource set Q, a PUCCH resource set in PUCCH-Config for unicast may be selected based on the payload size of the HARQ-ACK for unicast PDSCH and the HARQ-ACK for group common PDSCH. The PUCCH resource may be selected from the PUCCH resource set based on PRI in a PDCCH scheduling the unicast PDSCH. In some implementations, for determination of the PUCCH resource set configured in the PUCCH-Config for unicast, besides the payload (size) of the HARQ-ACK for unicast PDSCH, (only) the payload (size) of the HARQ-ACK for group common PDSCH with corresponding PDCCH ends before (or ends not after) the last PDCCH scheduling unicast PDSCH with corresponding HARQ-ACK to be transmitted in unicast PUCCH in the slot n may be considered.

In some implementations, a HARQ-ACK for group common PDSCH with corresponding PDCCH ends not before (or ends after) the last PDCCH scheduling a unicast PDSCH with corresponding HARQ-ACK to be transmitted in a unicast PUCCH in a slot n may not be multiplexed in the unicast PUCCH. In some implementations, the HARQ-ACK for group common PDSCH with corresponding PDCCH ends not before (or ends after) the last PDCCH scheduling unicast PDSCH with corresponding HARQ-ACK to be transmitted in the unicast PUCCH in the slot n may be multiplexed in the unicast PUCCH if the group common PDCCH ends not within N3 symbols before the start of the unicast PUCCH.

In some implementations, when there is no HARQ-ACK for unicast PDSCH scheduled in a slot, after a UCI multiplexing procedure is performed for a unicast PUCCH in the slot, and when a PUCCH resource configured by multi-CSI-PUCCH-ResourceList is determined to be used for transmitting more than one CSI report, if a multicast PUCCH is overlapping the PUCCH resource, a HARQ-ACK for group common PDSCH may be multiplexed in the PUCCH resource. The number of PRBs for the PUCCH transmission may be determined based on the payload size of the more than one CSI reports and the HARQ-ACK for group common PDSCH, and the maximum code rate of a PUCCH format.

In some implementations, when SPS-PUCCH-AN-List-r16 is not configured in PUCCH-Config for multicast and when more than one group common PDSCH has a corresponding HARQ-ACK configured to be transmitted in a slot, a PUCCH may be selected from PUCCH resources configured by SPS-PUCCH-AN-List-r16 configured in PUCCH-Config for unicast based on the payload size of the HARQ-ACK for group common PDSCH without a corresponding PDCCH and the HARQ-ACK for unicast PDSCH without a corresponding PDCCH that is configured to be transmitted in the slot. When PUCCH-Config for multicast is configured and when one group common PDSCH has a corresponding HARQ-ACK configured to be transmitted in a slot, n1PUCCH-AN in SPS-Config for the group common PDSCH may indicate a PUCCH resource configured by PUCCH-Config for multicast. When PUCCH-Config for multicast is not configured and when one group common PDSCH has the corresponding HARQ-ACK configured to be transmitted in the slot, n1PUCCH-AN in SPS-Config for multicast may indicate a PUCCH resource configured by PUCCH-Config for unicast.

In some implementations, when there is (only) a unicast PUCCH overlapping a multicast PUCCH in a slot (or in a group of overlapping PUCCH resources) in a UCI multiplexing procedure, a HARQ-ACK for group common PDSCH without a corresponding PDCCH may be multiplexed in the unicast PUCCH. The unicast PUCCH may be configured by SPS-PUCCH-AN-List-r16 in PUCCH-Config for unicast. The multicast PUCCH may be configured by SPS-PUCCH-AN-List-r16 in PUCCH-Config for multicast or configured by n1PUCCH-AN in SPS-Config for multicast. In some implementations, the unicast PUCCH for multiplexing the HARQ-ACK for unicast PDSCH without the corresponding PDCCH and the HARQ-ACK for group common PDSCH without the corresponding PDCCH may be selected from PUCCH resources configured by SPS-PUCCH-AN-List-r16 in PUCCH-Config for unicast based on the total payload size of the multiplexed HARQ-ACK.

In some implementations, when there is (only) a unicast PUCCH overlapping a CSI PUCCH and when there is (only) a multicast PUCCH overlapping the same CSI PUCCH in a slot (or in a group of overlapping PUCCH resources) in a UCI multiplexing procedure, (only) the unicast PUCCH may be multiplexed in the CSI PUCCH. The unicast PUCCH may be configured by SPS-PUCCH-AN-List-r16 in PUCCH-Config for unicast or configured by n1PUCCH-AN in SPS-Config for unicast. The multicast PUCCH may be configured by SPS-PUCCH-AN-List-r16 in PUCCH-Config for multicast or configured by n1PUCCH-AN in SPS-Config for multicast.

In some implementations, when there is (only) a unicast PUCCH overlapping more than one non-overlapping CSI PUCCH and when there is (only) a multicast PUCCH overlapping the same more than one non-overlapping CSI PUCCH in a slot (or in a group of overlapping PUCCH resources) in a UCI multiplexing procedure, the unicast PUCCH may be multiplexed in the CSI PUCCH with CSI report of higher priority and the multicast PUCCH may be multiplexed in the CSI PUCCH with CSI report of lower priority. The unicast PUCCH may be configured by SPS-PUCCH-AN-List-r16 in PUCCH-Config for unicast or configured by n1PUCCH-AN in SPS-Config for unicast. The multicast PUCCH may be configured by SPS-PUCCH-AN-List-r16 in PUCCH-Config for multicast or configured by n1PUCCH-AN in SPS-Config for multicast.

In the above implementations, a slot for an associated PUCCH transmission may include one or more symbols indicated by subslotLengthForPUCCH-r16 if the UE is provided subslotLengthForPUCCH-r16.

It should be noted that the above implementations may be applicable to PUCCHs with the same physical layer priority. In other words, the implementations may be applicable to the first PUCCH-Config in PUCCH-ConfigurationList for unicast and the first PUCCH-Config in PUCCH-ConfigurationList for multicast, and may be applicable to the second PUCCH-Config in PUCCH-ConfigurationList for unicast and the second PUCCH-Config in PUCCH-ConfigurationList for multicast.

### Type-1 HARQ-ACK Codebook

Implementations for determining the size of a Type-1 HARQ-ACK codebook may be as follows.

When the types of a HARQ-ACK codebook for the HARQ-ACK for multicast PUCCH and a HARQ-ACK codebook for the HARQ-ACK for unicast PUCCH are both Type-1 HARQ-ACK codebooks, parameters for both of a multicast configuration and a dedicated configuration may (need to) be considered for the determination (e.g., construction) of the Type-1 HARQ-ACK codebook. Combination (e.g., union) of a TDRA table in a dedicated PDSCH-Config and a TDRA table in a PDSCH-Config for multicast may be used to determine PDSCH candidate positions for the determination of the Type-1 HARQ-ACK codebook. The motivation of the implementations may include, but is not limited to, that determine a (joint)Type-1 HARQ-ACK codebook with a size that is not affected by dynamic scheduling or reception of a unicast PDSCH and a multicast PDSCH. That is, the Type-1 HARQ-ACK codebook may be used to multiplex the Type-1 HARQ-ACK codebook for unicast PDSCH and the Type-1 HARQ-ACK codebook for multicast PDSCH or may be used to transmit (only) the Type-1 HARQ-ACK codebook for unicast PDSCH. The size of the (joint) Type-1 HARQ-ACK codebook may be the same for the former implementations and/or the latter implementations.

In some implementations, for PDSCH with repetitions, a PDSCH candidate position with a symbol allocation defined by an SLIV may be checked in a plurality of slots to determine whether a corresponding HARQ-ACK bit is present in a Type-1 HARQ-ACK codebook to be transmitted in a UL slot n for a K1 value. The plurality of slots may be the X consecutive DL slots with the last DL slot being K1 slots before the UL slot n. If there is at least one DL slot in which the symbols indicated by the SLIV defining the symbol allocation of the PDSCH candidate position do not conflict with semi-static UL symbols indicated by tdd-UL-DL-ConfigurationCommon or tdd-UL-DL-ConfigurationDedicated, the PDSCH candidate position may be (considered as) valid and there may be the corresponding HARQ-ACK bit in the Type-1 HARQ-ACK codebook to be transmitted in the UL slot n for the K1 value. X may be determined as the maximum of pdsch-AggregationFactor (e.g., number of PDSCH repetitions) in PDSCH-Config for unicast and pdsch-AggregationFactor in PDSCH-Config for multicast. In some implementations, X may be determined as the maximum of pdsch-AggregationFactor in PDSCH-Config for unicast, pdsch-AggregationFactor in PDSCH-Config for multicast, pdsch-AggregationFactor in one or more SPS-Config for unicast, and pdsch-AggregationFactor in one or more SPS-Config for multicast. A valid PDSCH candidate position may correspond to two HARQ-ACK bits if the maximum of maxNrofCodeWordsScheduledByDCI in PDSCH-Config for unicast and maxNrofCodeWordsScheduledByDCI in PDSCH-Config for multicast is 2. Otherwise, the valid PDSCH candidate position may correspond to one HARQ-ACK bit.

In some implementations, the implementations may (only) be applicable for the Type-1 HARQ-ACK codebook transmitted in a PUCCH configured by PUCCH-Config for unicast since PUCCH resources configured by the PUCCH-Config for unicast are used to multiplex HARQ-ACK for group common PDSCH and HARQ-ACK for unicast PDSCH when a unicast PUCCH and a multicast PUCCH are in the same slot or are overlapping. The multiplexing implementations may be the above implementations. In other words, the Type-1 HARQ-ACK codebook transmitted in the PUCCH configured by PUCCH-Config for multicast may not consider pdsch-AggregationFactor and maxNrofCodeWordsScheduledByDCI in PDSCH-Config for unicast.

In some implementations, when SPS-PUCCH-AN-List-r16 configured in PUCCH-Config for multicast may be used to multiplex a PUCCH configured by the SPS-PUCCH-AN-List-r16 configured in PUCCH-Config for unicast or a PUCCH configured by n1PUCCH-AN in SPS-Config for unicast or when a PUCCH configured by the SPS-PUCCH-AN-List-r16 configured in the PUCCH-Config for unicast or a PUCCH configured by the n1PUCCH-AN in the SPS-Config for unicast may be multiplexed in a PUCCH configured by PUCCH-Config for multicast, a Type-1 HARQ-ACK codebook transmitted in the PUCCH configured by PUCCH-Config for multicast may consider pdsch-AggregationFactor in at least one of PDSCH-Config for multicast, pdsch-AggregationFactor in one or more SPS-Config for multicast, or pdsch-AggregationFactor in one or more SPS-Config for unicast.

In some implementations, for a Type-1 HARQ-ACK codebook transmitted in the PUCCH configured by PUCCH-Config for multicast, a separate PDSCH-CodeBlockGroupTransmission (specifically) for the PUCCH-Config for multicast may be provided in PDSCH-ServingCellConfig (e.g., PDSCH-CodeBlockGroupTransmissionMulticast). If the PDSCH-CodeBlockGroupTransmission (specifically) for the PUCCH-Config for multicast is not provided, (only) HARQ-ACK corresponding to TB in a group common PDSCH may be included in the Type-1 HARQ-ACK codebook transmitted in the PUCCH configured by the PUCCH-Config for multicast.

In some implementations, a group common PDSCH without a corresponding PDCCH (e.g., SPS group common PDSCH) may be activated and released by a group common PDCCH with CRC scrambled by G-CS-RNTI, or may be activated and released by a unicast PDCCH with CRC scrambled by CS-RNTI or G-CS-RNTI. For determination of a HARQ-ACK bit location in a Type-1 HARQ-ACK codebook for SPS release DCI releasing a SPS group common PDSCH of a SPS configuration, an SLIV used in the activation DCI for a TDRA of the SPS group common PDSCH of the SPS configuration may be used to determine the HARQ-ACK bit location for the SPS release DCI. When the group common PDCCH with CRC scrambled by G-CS-RNTI is used to release a SPS group common PDSCH of a SPS configuration, the corresponding HARQ-ACK bit may be transmitted in a PUCCH configured by PUCCH-Config for multicast. When the unicast PDCCH with CRC scrambled by CS-RNTI or G-CS-RNTI is used to release the SPS group common PDSCH of the SPS configuration, the corresponding HARQ-ACK bit may be transmitted in a PUCCH configured by PUCCH-Config for unicast.

It should be noted that since SPS-ConfigIndex is shared between SPS-Config for unicast and SPS-Config for multicast, of which SPS configuration the SPS group common PDSCH is released (or whether the released SPS group common PDSCH is of SPS configuration for multicast (or SPS configuration for unicast)) may be determined by the sps-ConfigIndex of the SPS configuration, and the SPS release DCI indicates an index equal to the sps-ConfigIndex (or an index that is mapped to one or more sps-ConfigIndex by a HARQ process number field). Mapping of an index to the one or more sps-ConfigIndex may be (configured) by an RRC configuration.

In some implementations, when a unicast PDCCH with CRC scrambled by CS-RNTI or G-CS-RNTI is used to release a SPS group common PDSCH of a SPS configuration, the corresponding HARQ-ACK bit may be transmitted in a PUCCH configured by PUCCH-Config for multicast.

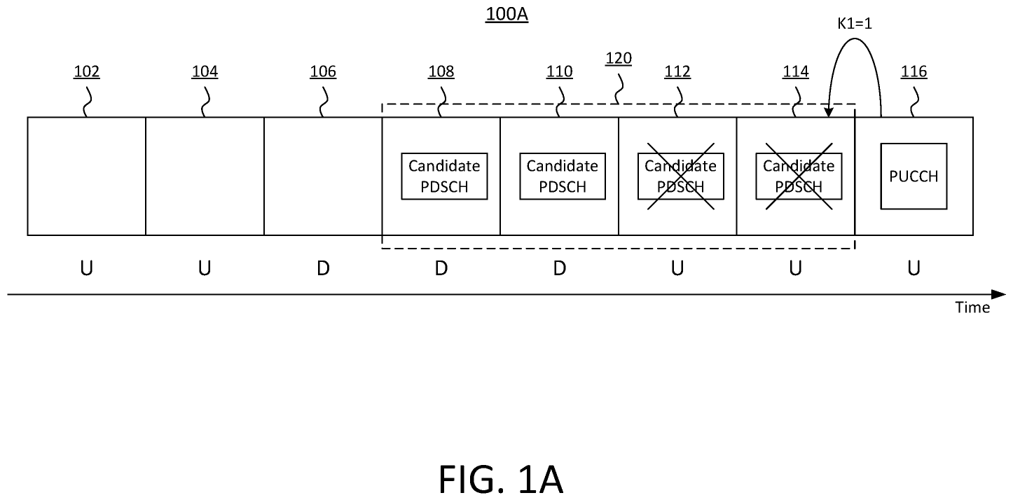

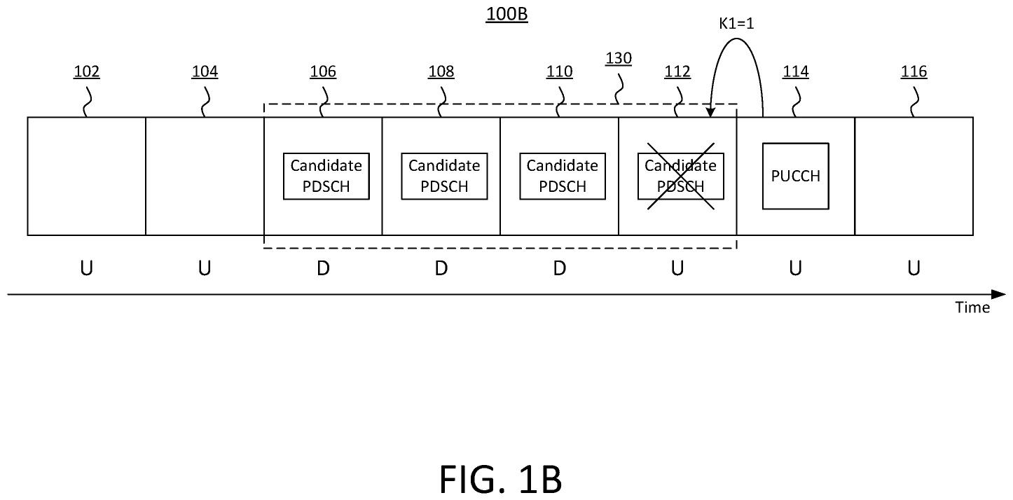

FIG. 1A illustrates a schematic diagram 100A regarding determination of a Type-1 HARQ-ACK codebook associated with one HARQ-ACK feedback offset according to an example implementation of the present disclosure.

Eight slots 102-116 are shown in FIG. 1A. For simplicity, all symbols in each of slots 102, 104, 112, 124, 116 (corresponding to “U”) are assumed to be UL symbols. All symbols in each of slots 106, 108, 110 (corresponding to “D”) are assumed to be DL symbols.

As shown in FIG. 1A, slot 116 is (scheduled) for PUCCH transmission. A total number/length of a set of slots is assumed to be 4, which is determined as the maximum value of the number of PDSCH repetitions configured in PDSCH-Config for unicast, the number of PDSCH repetitions configured in one or more SPS-Config for unicast, and the number of PDSCH repetitions configured in one or more SPS-Config for multicast. A HARQ-ACK feedback offset (e.g., configured by a PUCCH configuration) is assumed to be (fixed as) 1 (i.e., k1=1). Accordingly, set of slot 120 (corresponding to “k1=1”) starts at slot 108 and ends at slot 114.

Two slots of set of slot 120 (e.g., slots 112, 114) correspond to “U” (e.g., include at least one UL symbol) and are unavailable slots (unavailable for PDSCH candidate(s)). Accordingly, slots 108, 110 are available for PDSCH candidate(s). Thus, one HARQ-ACK bit corresponding to set of slot 120 is included in a Type-1 HARQ-ACK codebook (e.g., when one HARQ-ACK feedback offset is configured).

It should be noted that the symbol structure/configuration (e.g., “U” or “D”) of each of slots, the total number/length of a set of slots, and the value of the HARQ-ACK feedback offset are not limited herein.

FIG. 1B illustrates a schematic diagram 100B regarding determination of a Type-1 HARQ-ACK codebook associated with one HARQ-ACK feedback offset according to an example implementation of the present disclosure. The slot structure/configuration in FIG. 1B are the same as that in FIG. 1A.

As shown in FIG. 1B, slot 114 is (scheduled) for PUCCH transmission. A total number/length of a set of slots is assumed to be (fixed as) 4. A HARQ-ACK feedback offset (e.g., configured by a PUCCH configuration) is assumed to be (fixed as) 1 (i.e., k1=1). Accordingly, set of slot 130 (corresponding to “k1=1”) starts at slot 106 and ends at slot 112.

One slot of set of slot 130 (e.g., slots 112) correspond to “U” (e.g., include at least one UL symbol) and is an unavailable slot (unavailable for PDSCH candidate). Accordingly, slots 106, 108, 110 are available for PDSCH candidate(s). Thus, one HARQ-ACK bit corresponding to set of slot 130 is included in a Type-1 HARQ-ACK codebook (e.g., when one HARQ-ACK feedback offset is configured).

It should be noted that the symbol structure/configuration (e.g., “U” or “D”) of each of slots, the total number/length of a set of slots, and the value of the HARQ-ACK feedback offset are not limited herein.

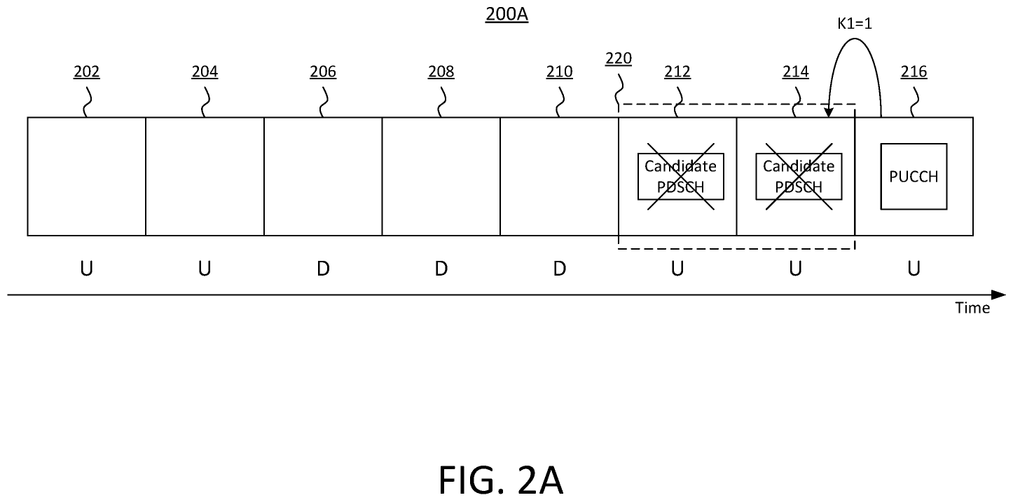

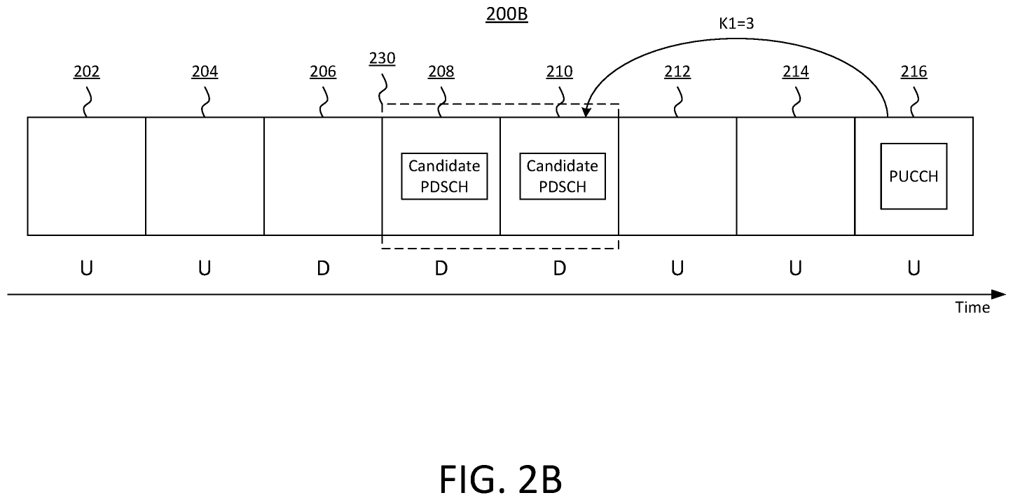

FIG. 2A illustrates a schematic diagram 200A regarding determination of a Type-1 HARQ-ACK codebook associated with multiple HARQ-ACK feedback offsets according to an example implementation of the present disclosure.

FIG. 2B illustrates a schematic diagram 200B regarding determination of a Type-1 HARQ-ACK codebook associated with multiple HARQ-ACK feedback offsets according to an example implementation of the present disclosure.

Specifically, one of multiple HARQ-ACK feedback offsets is considered in FIG. 2A, and another one of the multiple HARQ-ACK feedback offsets is considered in FIG. 2B.

Eight slots 202-216 are shown in FIGS. 2A-2B. For simplicity, all symbols in each of slots 202, 204, 212, 224, 216 (corresponding to “U”) are assumed to be UL symbols. All symbols in each of slots 206, 208, 210 (corresponding to “D”) are assumed to be DL symbols.

As shown in FIG. 2A, slot 216 is (scheduled) for PUCCH transmission. A total number/length of a set of slots is assumed to be 2, which is determined as the maximum value of the number of PDSCH repetitions configured in PDSCH-Config for unicast, the number of PDSCH repetitions configured in one or more SPS-Config for unicast, and the number of PDSCH repetitions configured in one or more SPS-Config for multicast. One of HARQ-ACK feedback offsets (e.g., configured by a PUCCH configuration) is assumed to be (fixed as) 1 (i.e., k1=1). Accordingly, set of slot 220 (corresponding to “k1=1”) starts at slot 212 and ends at slot 214.

Two slots of set of slot 220 (e.g., slots 212, 214) correspond to “U” (e.g., include at least one UL symbol) and are unavailable slots (unavailable for PDSCH candidate(s)). Accordingly, no slot is available for PDSCH candidate(s). Thus, no HARQ-ACK bit corresponding to “k1=1” is included in a Type-1 HARQ-ACK codebook.

As shown in FIG. 2B, another one of HARQ-ACK feedback offsets (e.g., configured by the same PUCCH configuration) is assumed to be (fixed as) 1 (i.e., k1=3). Accordingly, set of slot 230 (corresponding to “k1=3”) starts at slot 208 and ends at slot 210.

Accordingly, slots 208, 210 are available for PDSCH candidate(s). Thus, one HARQ-ACK bit corresponding to set of slot 230 corresponding to “k1=3” is included in the same Type-1 HARQ-ACK codebook.

It should be noted that the symbol structure/configuration (e.g., “U” or “D”) of each of slots, the total number/length of a set of slots, and the value of the HARQ-ACK feedback offset are not limited herein.

### DAI in UL Grant

Implementations for determining a DAI field in a UL grant may be as follows.

In some implementations, for a DCI format 0_1, for a given physical layer priority, a first DAI (e.g., 1st downlink assignment index) may be with 4 bits if a dynamic HARQ-ACK codebook is configured for both multicast PUCCH and unicast PUCCH, the first DAI may be with 2 bits if the dynamic HARQ-ACK codebook is configured for both multicast PUCCH and unicast PUCCH and if a HARQ-ACK feedback for group common PDSCH is disabled by an RRC configuration, and the first DAI may be with 1 bit if a semi-static HARQ-ACK codebook is configured for both multicast PUCCH and unicast PUCCH. The motivation of the design/mechanism may include, but is not limit to, that when the dynamic HARQ-ACK codebook is configured for both multicast PUCCH and unicast PUCCH, besides the 2 bits of UL-DAI for Type-2 HARQ-ACK codebook for unicast PDSCH, 2 additional bits of UL-DAI may be needed to indicate the total DAI of the Type-2 HARQ-ACK codebook for multicast PDSCH, since the DAI values of the Type-2 HARQ-ACK codebook for unicast PDSCH and the DAI values of the Type-2 HARQ-ACK codebook for multicast PDSCH are independently assigned.

It should be noted that if the additional bits of UL-DAI are not considered, the UE may multiplex the Type-2 HARQ-ACK codebook for multicast PDSCH with an incorrect size in a PUSCH scheduled by DCI, which may result in incorrect reception of the PUSCH by a gNB. On the other hands, when the semi-static HARQ-ACK codebook is configured for both multicast PUCCH and unicast PUCCH, no additional bits of UL-DAI may be needed since a joint Type-1 HARQ-ACK codebook is determined (e.g., constructed). For example, the 1 bit UL-DAI for Type-1 HARQ-ACK codebook for unicast PDSCH may be used to indicate whether the (joint) Type-1 HARQ-ACK codebook should be multiplexed in a PUSCH scheduled by DCI.

In some implementations, a second DAI (e.g., 2nd downlink assignment index) may be with 2 bits if pdsch-CodeBlockGroupTransmissionList provides pdsch-CodeBlockGroupTransmission for unicast PUCCH of the physical layer priority, if pdsch-CodeBlockGroupTransmissionList provides pdsch-CodeBlockGroupTransmission for multicast PUCCH of the physical layer priority, or if pdsch-CodeBlockGroupTransmissionList provides pdsch-CodeBlockGroupTransmission for unicast PUCCH of the physical layer priority and provides pdsch-CodeBlockGroupTransmission for multicast PUCCH of the physical layer priority and if the HARQ-ACK feedback for group common PDSCH is disabled by the RRC configuration, the second DAI may be with 4 bits if pdsch-CodeBlockGroupTransmissionList provides pdsch-CodeBlockGroupTransmission for unicast PUCCH of the physical layer priority and provides pdsch-CodeBlockGroupTransmission for multicast PUCCH of the physical layer priority. Otherwise, the second DAI may be with 0 bit.

It should be noted that pdsch-CodeBlockGroupTransmissionList may provide up to four pdsch-CodeBlockGroupTransmission for unicast PUCCH of low physical layer priority, for unicast PUCCH of high physical layer priority, for multicast PUCCH of low physical layer priority, and for multicast PUCCH of high physical layer priority, respectively.

In some implementations, when PUCCH-Config for HARQ-ACK codebooks associated with different physical layer priorities are configured for the same serving cell, if the bit width of the first DAI in the DCI format 0_1 for one physical layer priority is not equal to that of the first DAI in the DCI format 0_1 for the other physical layer priority, one or more MSBs with value set to ‘0’ may be inserted to the smaller first DAI until the bit width of the first DAI in the DCI format 0_1 for the two physical layer priorities are the same.

In some implementations, when PUCCH-Config for HARQ-ACK codebooks associated with different physical layer priorities are configured for the same serving cell, if the bit width of the second DAI in the DCI format 0_1 for one physical layer priority is not equal to that of the second DAI in the DCI format 0_1 for the other physical layer priority, one or more MSBs with value set to ‘0’ may be inserted to the smaller second DAI until the bit width of the second DAI in the DCI format 0_1 for the two physical layer priorities are the same.

In some implementations, for a DCI format 0_2, for a given physical layer priority, a first DAI (e.g., 1st downlink assignment index) may be with 4 bits if a dynamic HARQ-ACK codebook is configured for both multicast PUCCH and unicast PUCCH, the first DAI may be with 2 bits if the dynamic HARQ-ACK codebook is configured for both multicast PUCCH and unicast PUCCH and if a HARQ-ACK feedback for group common PDSCH is disabled by an RRC configuration, and the first DAI may be with 1 bit if a semi-static HARQ-ACK codebook is configured for both multicast PUCCH and unicast PUCCH. The motivation of the design/mechanism may include, but is not limit to, that when the dynamic HARQ-ACK codebook is configured for both multicast PUCCH and unicast PUCCH, besides the 2 bits of UL-DAI for Type-2 HARQ-ACK codebook for unicast PDSCH, 2 additional bits of UL-DAI may be needed to indicate the total DAI of the Type-2 HARQ-ACK codebook for multicast PDSCH, since the DAI values of the Type-2 HARQ-ACK codebook for unicast PDSCH and the DAI values of the Type-2 HARQ-ACK codebook for multicast PDSCH are independently assigned.

It should be noted that if the additional bits of UL-DAI are not considered, the UE may multiplex the Type-2 HARQ-ACK codebook for multicast PDSCH with an incorrect size in a PUSCH scheduled by DCI, which may result in incorrect reception of the PUSCH by a gNB. On the other hands, when the semi-static HARQ-ACK codebook is configured for both multicast PUCCH and unicast PUCCH, no additional bits of UL-DAI may be needed since a joint Type-1 HARQ-ACK codebook is determined (e.g., constructed). For example, the 1 bit UL-DAI for Type-1 HARQ-ACK codebook for unicast PDSCH may be used to indicate whether the (joint) Type-1 HARQ-ACK codebook should be multiplexed in a PUSCH scheduled by DCI.

In some implementations, a second DAI (e.g., 2nd downlink assignment index) may be with 2 bits if pdsch-CodeBlockGroupTransmissionList provides pdsch-CodeBlockGroupTransmission for unicast PUCCH of the physical layer priority, if pdsch-CodeBlockGroupTransmissionList provides pdsch-CodeBlockGroupTransmission for multicast PUCCH of the physical layer priority, or if pdsch-CodeBlockGroupTransmissionList provides pdsch-CodeBlockGroupTransmission for unicast PUCCH of the physical layer priority and provides pdsch-CodeBlockGroupTransmission for multicast PUCCH of the physical layer priority and if the HARQ-ACK feedback for group common PDSCH is disabled by the RRC configuration, the second DAI may be with 4 bits if pdsch-CodeBlockGroupTransmissionList provides pdsch-CodeBlockGroupTransmission for unicast PUCCH of the physical layer priority and provides pdsch-CodeBlockGroupTransmission for multicast PUCCH of the physical layer priority. Otherwise, the second DAI may be with 0 bit.

It should be noted that pdsch-CodeBlockGroupTransmissionList may provide up to four pdsch-CodeBlockGroupTransmission for unicast PUCCH of low physical layer priority, for unicast PUCCH of high physical layer priority, for multicast PUCCH of low physical layer priority, and for multicast PUCCH of high physical layer priority, respectively.

In some implementations, when PUCCH-Config for HARQ-ACK codebooks associated with different physical layer priorities are configured for the same serving cell, if the bit width of the first DAI in the DCI format 0_2 for one physical layer priority is not equal to that of the first DAI in the DCI format 0_2 for the other physical layer priority, one or more MSBs with value set to ‘0’ may be inserted to the smaller first DAI until the bit width of the first DAI in the DCI format 0_2 for the two physical layer priorities are the same.

In some implementations, when PUCCH-Config for HARQ-ACK codebooks associated with different physical layer priorities are configured for the same serving cell, if the bit width of the second DAI in the DCI format 0_2 for one physical layer priority is not equal to that of the second DAI in the DCI format 0_2 for the other physical layer priority, one or more MSBs with value set to ‘0’ may be inserted to the smaller second DAI until the bit width of the second DAI in the DCI format 0_2 for the two physical layer priorities are the same.

In some implementations, if Downlinkassignmentindex-ForDCIFormat0_2 is not configured, the first DAI and the second DAI may be with 0 bit.

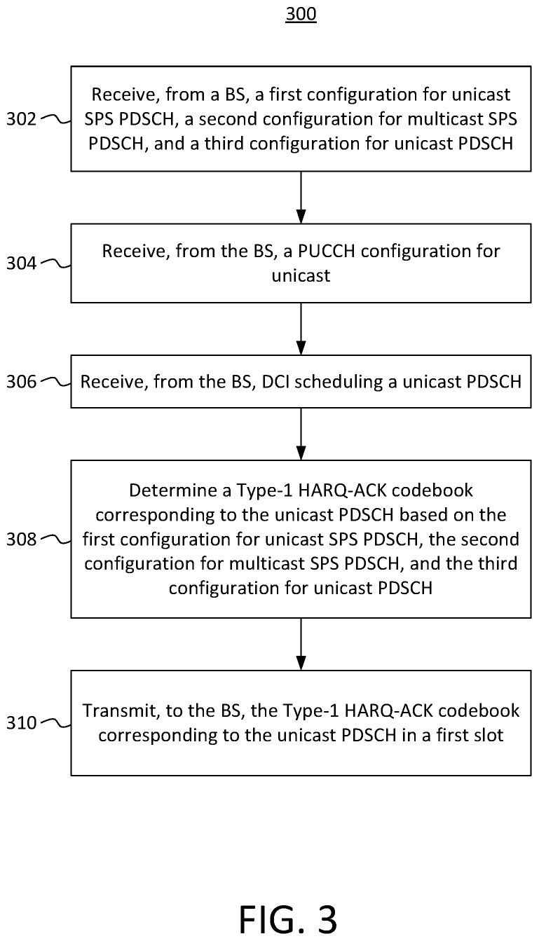

FIG. 3 is a flowchart illustrating a method 300 for handling HARQ-ACK codebook transmission performed by a UE according to an example implementation of the present disclosure. In action 302, the UE may receive, from a BS, a first configuration for unicast SPS PDSCH, a second configuration for multicast SPS PDSCH, and a third configuration for unicast PDSCH. In action 304, the UE may receive, from the BS, a PUCCH configuration for unicast. In action 306, the UE may receive, from the BS, DCI scheduling a unicast PDSCH. In action 308, the UE may determine a Type-1 HARQ-ACK codebook corresponding to the unicast PDSCH based on (or according to) the first configuration for unicast SPS PDSCH, the second configuration for multicast SPS PDSCH, and the third configuration for unicast PDSCH. In action 310, the UE may transmit, to the BS, the Type-1 HARQ-ACK codebook corresponding to the unicast PDSCH in a first slot.

In some implementations, the first configuration for unicast SPS PDSCH may configure a first number of PDSCH repetitions. The second configuration for multicast SPS PDSCH may configure a second number of PDSCH repetitions. The third configuration for unicast PDSCH may configure a third number of PDSCH repetitions.

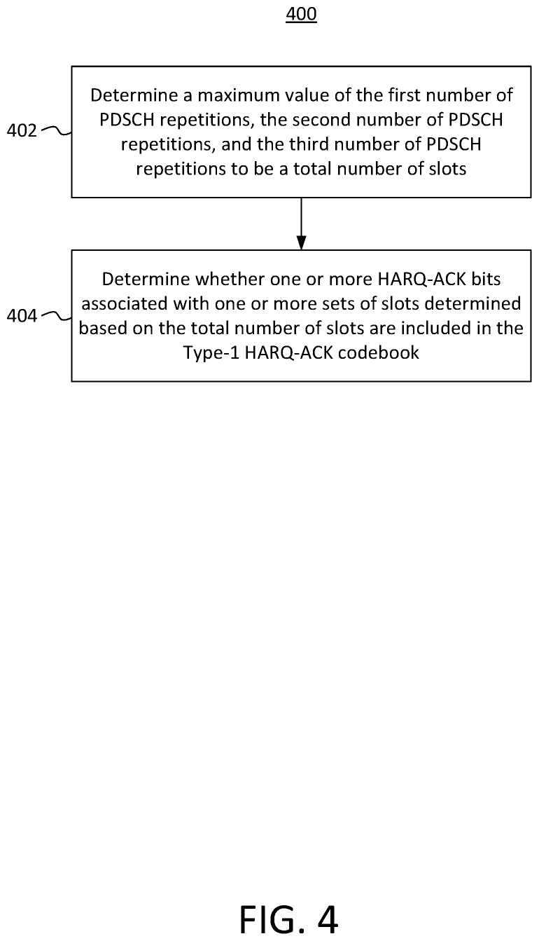

FIG. 4 is a flowchart illustrating a method 400 for determining a Type-1 HARQ-ACK codebook corresponding to a unicast PDSCH based on a first configuration for unicast SPS PDSCH, a second configuration for multicast SPS PDSCH, and a third configuration for unicast PDSCH performed by a UE (e.g., the UE performing the method 300) according to an example implementation of the present disclosure. In action 402, the UE may determine a maximum value of the first number of PDSCH repetitions, the second number of PDSCH repetitions, and the third number of PDSCH repetitions to be a total number of slots (e.g., N_{PDSCH}^{repeat,max}). In action 404, the UE may determine whether one or more HARQ-ACK bits associated with one or more sets of slots are included in the Type-1 HARQ-ACK codebook. The one or more sets of slots may be determined based on the total number of slots.

In some implementations, a length of each of the one or more sets of slots may be the total number of slots.

In some implementations, the UE may obtain one or more HARQ-ACK feedback offsets according to the PUCCH configuration. The UE may determine the one or more sets of slots corresponding to the one or more HARQ-ACK feedback offsets based on the one or more HARQ-ACK feedback offsets. The UE may determine that a HARQ-ACK bit of the one or more HARQ-ACK bits is included in the Type-1 HARQ-ACK codebook in a case that a PDSCH candidate position corresponding to the HARQ-ACK bit does not conflict with an unavailable symbol in a set of slots of the one or more sets of slots. The HARQ-ACK bit may be associated with the set of slots corresponding to a HARQ-ACK feedback offset of the one or more HARQ-ACK feedback offsets. A length of the set of slots may be the total number of slots. An ending slot of the set of slots may be a second slot. The second slot may be the HARQ-ACK feedback offset prior to the first slot. The unavailable symbol may be an uplink symbol.

In some implementations, the one or more HARQ-ACK feedback offsets may be configured by the PUCCH configuration.

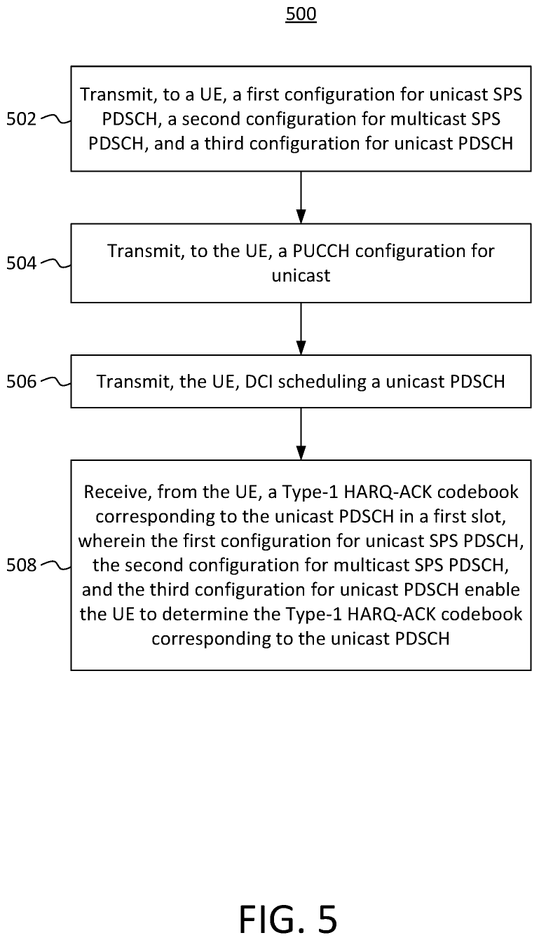

FIG. 5 is a flowchart illustrating a method 500 for handling HARQ-ACK codebook reception performed by a BS according to an example implementation of the present disclosure. In action 502, the BS may transmit, to a UE, a first configuration for unicast SPS PDSCH, a second configuration for multicast SPS PDSCH, and a third configuration for unicast PDSCH. In action 504, the BS may transmit, to the UE, a PUCCH configuration for unicast. In action 506, the BS may transmit, to the UE, DCI scheduling a unicast PDSCH. In action 508, the BS may receive, from the UE, a Type-1 HARQ-ACK codebook corresponding to the unicast PDSCH in a first slot. The first configuration for unicast SPS PDSCH, the second configuration for multicast SPS PDSCH, and the third configuration for unicast PDSCH may enable the UE to determine the Type-1 HARQ-ACK codebook corresponding to the unicast PDSCH.

In some implementations, the first configuration for unicast SPS PDSCH may configure a first number of PDSCH repetitions. The second configuration for multicast SPS PDSCH may configure a second number of PDSCH repetitions. The third configuration for unicast PDSCH may configure a third number of PDSCH repetitions.

In some implementations, the PUCCH configuration configures one or more HARQ-ACK feedback offsets.

In some implementations, the Type-1 HARQ-ACK codebook is received via a PUCCH from one or more PUCCHs configured by the PUCCH configuration.

It should be noted that the order in which the process is described is not intended to be construed as a limitation, and any number of the described actions may be combined in any order to implement the method or an alternate method. Moreover, one or more of the actions illustrated in FIGS. 1 through 4 may be omitted in some implementations.

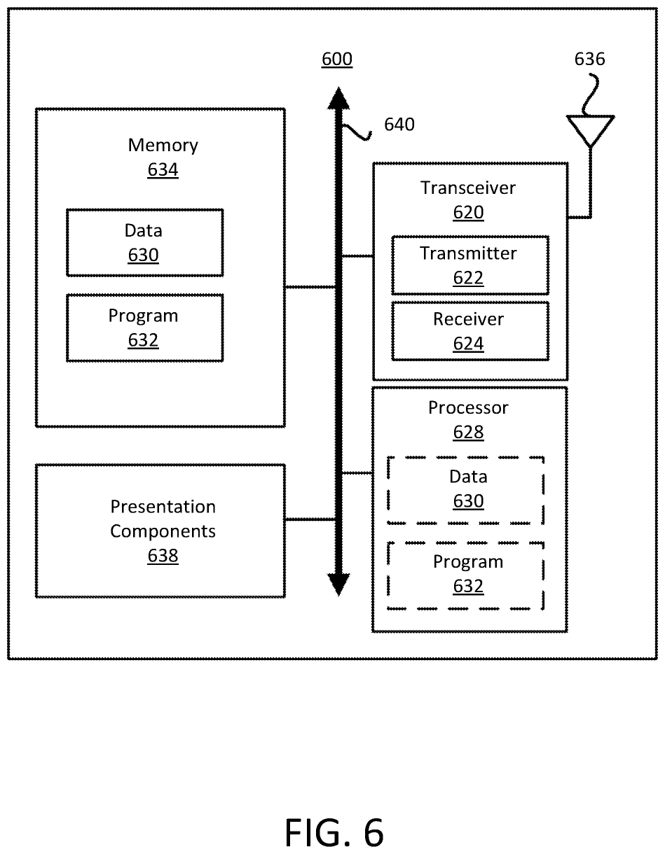

FIG. 6 is a block diagram illustrating a node 600 for wireless communication according to an example implementation of the present disclosure. As illustrated in FIG. 6, a node 600 may include a transceiver 620, a processor 628, a memory 634, one or more presentation components 638, and at least one antenna 636. The node 600 may also include a RF spectrum band module, a BS communications module, a network communications module, and a system communications management module, Input/Output (I/O) ports, I/O components, and a power supply (not illustrated in FIG. 6).

Each of the components may directly or indirectly communicate with each other over one or more buses 640. The node 600 may be a UE or a BS that performs various functions disclosed with reference to FIGS. 1 through 6.

The transceiver 620 has a transmitter 622 (e.g., transmitting/transmission circuitry) and a receiver 624 (e.g., receiving/reception circuitry) and may be configured to transmit and/or receive time and/or frequency resource partitioning information. The transceiver 620 may be configured to transmit in different types of subframes and slots including but not limited to usable, non-usable and flexibly usable subframes and slot formats. The transceiver 620 may be configured to receive data and control channels.

The node 600 may include a variety of computer-readable media. Computer-readable media may be any available media that may be accessed by the node 600 and include both volatile and non-volatile media, removable and non-removable media.

The computer-readable media may include computer storage media and communication media. Computer storage media include both volatile and non-volatile, removable and non-removable media implemented in any method or technology for storage of information such as computer-readable instructions, data structures, program modules or data.

Computer storage media include RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media do not include a propagated data signal. Communication media typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the previously listed components should also be included within the scope of computer-readable media.

The memory 634 may include computer-storage media in the form of volatile and/or non-volatile memory. The memory 634 may be removable, non-removable, or a combination thereof. Example memory includes solid-state memory, hard drives, optical-disc drives, etc. As illustrated in FIG. 6, the memory 634 may store computer-readable, computer-executable instructions 632 (e.g., software codes) that are configured to cause the processor 628 to perform various disclosed functions, for example, with reference to FIGS. 1 through 6. Alternatively, the instructions 632 may not be directly executable by the processor 628 but be configured to cause the node 600 (e.g., when compiled and executed) to perform various disclosed functions.

The processor 628 (e.g., having processing circuitry) may include an intelligent hardware device, e.g., a Central Processing Unit (CPU), a microcontroller, an ASIC, etc. The processor 628 may include memory. The processor 628 may process data 630 and the instructions 632 received from the memory 634, and information transmitted and received via the transceiver 620, the base band communications module, and/or the network communications module. The processor 628 may also process information to be sent to the transceiver 620 for transmission via the antenna 636 to the network communications module for transmission to a CN.

One or more presentation components 638 present data indications to a person or another device. Examples of presentation components 638 include a display device, a speaker, a printing component, and a vibrating component, etc.

In view of the present disclosure, it is obvious that various techniques may be used for implementing the concepts in the present disclosure without departing from the scope of those concepts. Moreover, while the concepts have been disclosed with specific reference to certain implementations, a person of ordinary skill in the art will recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method for handling hybrid automatic repeat request (HARQ)-acknowledgment (ACK) codebook transmission performed by a user equipment (UE), the method comprising:
receiving, from a base station (BS), a first configuration for unicast semi-persistent scheduling (SPS) physical downlink shared channel (PDSCH), a second configuration for multicast SPS PDSCH, and a third configuration for unicast PDSCH;
receiving, from the BS, a physical uplink control channel (PUCCH) configuration for unicast;
receiving, from the BS, downlink control information (DCI) scheduling a unicast PDSCH;
determining a Type-1 HARQ-ACK codebook corresponding to the unicast PDSCH based on the first configuration for unicast SPS PDSCH, the second configuration for multicast SPS PDSCH, and the third configuration for unicast PDSCH; and
transmitting, to the BS, the Type-1 HARQ-ACK codebook corresponding to the unicast PDSCH in a first slot.

2. The method of claim 1, wherein:
the first configuration for unicast SPS PDSCH configures a first number of PDSCH repetitions;
the second configuration for multicast SPS PDSCH configures a second number of PDSCH repetitions; and
the third configuration for unicast PDSCH configures a third number of PDSCH repetitions.

3. The method of claim 2, wherein determining the Type-1 HARQ-ACK codebook based on the first configuration for unicast SPS PDSCH, the second configuration for multicast SPS PDSCH, and the third configuration for unicast PDSCH comprises:
determining a maximum value of the first number of PDSCH repetitions, the second number of PDSCH repetitions, and the third number of PDSCH repetitions to be a total number of slots; and
determining whether one or more HARQ-ACK bits associated with one or more sets of slots determined based on the total number of slots are included in the Type-1 HARQ-ACK codebook.

4. The method of claim 3, wherein determining the Type-1 HARQ-ACK codebook based on the first configuration for unicast SPS PDSCH, the second configuration for multicast SPS PDSCH, and the third configuration for unicast PDSCH further comprises:
obtaining one or more HARQ-ACK feedback offsets according to the PUCCH configuration;
determining the one or more sets of slots corresponding to the one or more HARQ-ACK feedback offsets based on the one or more HARQ-ACK feedback offsets; and
determining that a HARQ-ACK bit of the one or more HARQ-ACK bits is included in the Type-1 HARQ-ACK codebook in a case that a PDSCH candidate position corresponding to the HARQ-ACK bit does not conflict with an unavailable symbol in a set of slots of the one or more sets of slots, wherein:
the HARQ-ACK bit is associated with the set of slots corresponding to a HARQ-ACK feedback offset of the one or more HARQ-ACK feedback offsets,
a length of the set of slots is the total number of slots,
an ending slot of the set of slots is a second slot,
the second slot is the HARQ-ACK feedback offset prior to the first slot, and
the unavailable symbol is an uplink symbol.

5. The method of claim 4, wherein the one or more HARQ-ACK feedback offsets are configured by the PUCCH configuration.

6. The method of claim 3, wherein a length of each of the one or more sets of slots is the total number of slots.

7. The method of claim 1, wherein:
the Type-1 HARQ-ACK codebook is transmitted via a PUCCH; and
the PUCCH is determined from one or more PUCCHs configured by the PUCCH configuration.

8. A user equipment (UE) for handling hybrid automatic repeat request (HARQ)-acknowledgment (ACK) codebook transmission, comprising:
one or more non-transitory computer-readable media having computer-executable instructions embodied therein; and
at least one processor coupled to the one or more non-transitory computer-readable media, the at least one processor configured to execute the computer-executable instructions to cause the UE to perform the method of any of claims 1 to 7.

9. A method for handling hybrid automatic repeat request (HARQ)-acknowledgment (ACK) codebook reception performed by a base station (BS), the method comprising:
transmitting, to a user equipment (UE), a first configuration for unicast semi-persistent scheduling (SPS) physical downlink shared channel (PDSCH), a second configuration for multicast SPS PDSCH, and a third configuration for unicast PDSCH;
transmitting, to the UE, a physical uplink control channel (PUCCH) configuration for unicast;
transmitting, to the UE, downlink control information (DCI) scheduling a unicast PDSCH; and
receiving, from the UE, a Type-1 HARQ-ACK codebook corresponding to the unicast PDSCH in a first slot, wherein the first configuration for unicast SPS PDSCH, the second configuration for multicast SPS PDSCH, and the third configuration for unicast PDSCH enable the UE to determine the Type-1 HARQ-ACK codebook corresponding to the unicast PDSCH.

10. The method of claim 9, wherein:
the first configuration for unicast SPS PDSCH configures a first number of PDSCH repetitions;
the second configuration for multicast SPS PDSCH configures a second number of PDSCH repetitions; and
the third configuration for unicast PDSCH configures a third number of PDSCH repetitions.

11. The method of claim 9, wherein the PUCCH configuration configures one or more HARQ-ACK feedback offsets.

12. The method of claim 9, wherein:
the Type-1 HARQ-ACK codebook is received via a PUCCH from one or more PUCCHs configured by the PUCCH configuration.

13. A base station (BS) for handling hybrid automatic repeat request (HARQ)-acknowledgment (ACK) codebook reception, comprising:
one or more non-transitory computer-readable media having computer-executable instructions embodied therein; and
at least one processor coupled to the one or more non-transitory computer-readable media, the at least one processor configured to execute the computer-executable instructions to cause the BS to perform the method of any of claims 9 to 12.
